(19) United States
(12) Patent Application Publication
(10) Pub. No.: US 2024/0342622 A1
(43) Pub. Date: Oct. 17, 2024

(54) REVERSIBLE PACKAGING

(71) Applicant: William WARKENTIN, West Bloomfield, MI (US)

(72) Inventor: William WARKENTIN, West Bloomfield, MI (US)

(21) Appl. No.: 18/756,431

(22) Filed: Jun. 27, 2024

Related U.S. Application Data
(63) Continuation-in-part of application No. 18/580,104, filed on Jan. 1, 0001.
(60) Provisional application No. 63/386,951, filed on Dec. 12, 2022.

(51) Int. Cl. A63H 27/10; G09F 21/06

(52) U.S. Cl. CPC A63H 27/10; G09F 21/06; A63H 2027/1058; A63H 2027/1075; A63H 2027/1083; A63H 2027/1091

(57) ABSTRACT

A balloon including an inflatable body operatively attached to a base on a proximal side, the base including a cavity for filling with items, wherein the inflatable body is inflated by an air vent or a fan operatively attached to the base. A method of using the balloon, by placing the balloon at a display location, flowing air through the inflatable body, inflating the inflatable body, and providing access to items within the cavity. Reversible packaging including a packaging body having a first design on a first side and a second design on a second side. A method of using reversible packaging, by a user purchasing a product contained within reversible packaging showing a first design, the user removing the reversible packaging and reversing the reversible packaging to show a second design, and the user securing the reversible packaging around the product showing the second design.

### BACKGROUND OF THE INVENTION

### 1. Technical Field

The present invention relates to balloons and inflatable objects and gift packaging. More specifically, the present invention relates to balloons for use with an air source having a storage base and reversible packaging for gift wrap.

### 2. Background Art

Balloons are used by many people for festive events and parties such as for birthdays, graduations, anniversaries, baby showers, retirements, and holidays. Helium balloons can be filled at a store but then must be transported to the home or event site in a car and can be cumbersome. Other standard balloons can be filled by blowing air at the home, but this can also be difficult and tiresome.

A balloon has been designed to fit over an air vent to be inflated by air flowing out of the air vent. U.S. Pat. No. 5,186,675 to Stoddard discloses an inflatable vent toy for an exhaust vent air outlet including an inflatable balloon made of a flexible material patterned and shaped to suit the preference of a user having a base defining an air inlet with surrounding attachment structure to secure the base over the exhaust vent air outlet such that the air inlet is in communication with the vent air outlet to enable in-coming air from the vent to enter the base air inlet and fill the balloon in a first mode, and to escape and collapse in a second mode when the in-coming air from the vent stops. The base structure is generally removably attached to the vent with magnets, ties, hooks, or straps. The inflatable vent toy can be in shapes such as a ghost or goblin, or contain pictures of athletes or movie characters. However, using a base of corrugated cardboard has the drawbacks of product liability with hot air vents, and cheap looking quality.

U.S. Pat. Nos. 10,588,996 and 10,751,439 to Applicant disclose vent balloons for use over air vents and/or fans including an inflatable body operatively attached to a base on a proximal side. The base can be cardboard or plastic and is a substantially flat or planar body.

It would be useful to provide gifts or promotional items with a balloon. There remains a need for a balloon that includes gifts or promotional items easily contained with the balloon. There further remains a need for easy to use gift packaging when purchasing items.

### SUMMARY OF THE INVENTION

The present invention provides for a balloon including an inflatable body operatively attached to a base on a proximal side, the base including a cavity for filling with items, wherein the inflatable body is inflated by a mechanism of an air vent or a fan operatively attached to the base.

The present invention also provides for a method of using the balloon, by placing the balloon at a display location, flowing air through the inflatable body, inflating the inflatable body, and providing access to items within the cavity.

The present invention provides for a reversible packaging including a packaging body having a first design on a first side and a second design on a second side, the packaging body being reversible and the packaging body including at least one sealing mechanism for sealing the reversible packaging around a product.

The present invention also provides for a method of using reversible packaging, by a user purchasing a product contained within reversible packaging showing a first design, the user removing the reversible packaging from around the product and reversing the reversible packaging to show a second design, and the user securing the reversible packaging around the product showing the second design.

### DESCRIPTION OF THE DRAWINGS

Other advantages of the present invention are readily appreciated as the same becomes better understood by reference to the following detailed description when considered in connection with the accompanying drawings wherein:

FIG. 1 is a front view of the balloon of the present invention;

FIG. 2A is a front view of a balloon with a congratulatory design, and FIG. 2B is a front view of a balloon with a holiday design;

FIG. 3A is a top view of a base, FIG. 3B is a front perspective view of the base, FIG. 3C is a side perspective view of the base, and FIG. 3D is a front view of the base;

FIG. 4 is a front perspective view of the base containing food items;

FIG. 5 is a front view of a balloon;

FIG. 6 is a front perspective view of a balloon folded with the base;

FIG. 7 is a flow chart demonstrating assembly of the balloon and base;

FIG. 8A is a front perspective view of a folded balloon and base, and FIG. 8B is a side perspective view of a folded balloon and base;

FIG. 9 is a bottom view of the base;

FIGS. 10A-1E show a base with air intake slots, FIG. 10A is a top view,

FIG. 10B is a side view, FIG. 10C is a view taken along section A-A of FIG. 10A,

FIG. 10D is a side view, and FIG. 10E is a top perspective view;

FIG. 11A is a perspective view of packaging, FIG. 11B is an exploded view of packaging and contents, FIG. 11C is a top view of packaging with a first design, and

FIG. 11D is a top view of packaging with a second design;

FIG. 12A is a front view of a balloon and base, FIG. 12B is a front view of packaging, FIG. 12D is a front perspective view of packaging, FIG. 12E is a front perspective view of packaging, FIG. 12F is a distal side perspective view of packaging, FIG. 12G is a side view of packaging and a base, FIG. 12H is a front view of contents of the packaging, FIG. 12I is a bottom perspective view of packaging with a first design, FIG. 12J is a bottom perspective view of packaging with a second design, and FIG. 12K is an exploded view of contents of the packaging;

FIG. 13 is a top view of a removable lid with an internal molded slot for batteries;

FIG. 14A is a perspective view of a first side of reversible packaging, FIG. 14B is an open view of a first side of reversible packaging showing a second design inside, FIG. 14C is a front perspective view of reversible packaging unfolded to refold showing a second design, FIG. 14D is a side perspective view of a second side of reversible packaging, and FIG. 14E is a front perspective view of reversible packaging showing a second side with a gift wrap design;

FIG. 15A is a top view of a first side of reversible packaging, FIG. 15B is a top view of a second side of reversible packaging, FIG. 15C is a side perspective view of a first side of reversible packaging, FIG. 15D is an open view of a first side of reversible packaging, FIG. 15E is a front perspective view of reversible packaging unfolded to refold showing a second design, FIG. 15F is a top view of reversible packaging with a first design inside, FIG. 15G is a top view of reversible packaging showing a second design inside, FIG. 15H is a bottom view of reversible packaging showing a first side, FIG. 15I is a front perspective view of a second side of reversible packaging, and FIG. 15J is a front perspective view of a second side of reversible packaging;

FIG. 16A is a top view of a first side of reversible packaging for a mug unfolded, FIG. 16B is a front perspective view of a first side of reversible packaging, FIG. 16C is a top view of a second side of reversible packaging unfolded with a celebratory greeting, FIG. 16D is a front perspective view of a first side of reversible packaging showing a second design inside, FIG. 16E is a front perspective view of a second side of reversible packaging, FIG. 16F is a top view of a second side of reversible packaging unfolded, FIG. 16G is a front perspective view of a second side of reversible packaging, and FIG. 16H is a front perspective view of a second side of reversible packaging showing a first design inside;

FIG. 17A is a side perspective view of reversible packaging with a top body and bottom body, FIG. 17B is a side perspective view of reversible packaging with a top body and bottom body, FIG. 17C is a side perspective view of reversible packaging with a top body and bottom body formed with a first design, FIG. 17D is a side perspective view of reversible packaging with a top body and bottom body, FIG. 17E is a side perspective view of reversible packaging with a top body and bottom body, and FIG. 17F is a side perspective view of reversible packaging with a top body and bottom body formed with a second design;

FIG. 18A shows a first step of reversing reversible packaging, FIG. 18B shows a second step of reversing reversible packaging, FIG. 18C shows a third step of reversing reversible packaging, FIG. 18D shows a fourth step of reversing reversible packaging, FIG. 18E shows a fifth step of reversing reversible packaging, FIG. 18F shows a sixth step of reversing reversible packaging, FIG. 18G shows a close up of the sixth step, and FIG. 18H shows an alternative design for a lid and front panel;

FIG. 19 shows a shirt inside reversible packaging;

FIG. 20A shows a large rectangle box, FIG. 20B shows a small rectangle box, and FIG. 20C shows a cube;

FIG. 21A is a top view of reversible packaging in an envelope shape with a first design, and FIG. 21B is a top view of reversible packaging in an envelope shape with a second design;

FIG. 22A is a side view of preparing to seal reversible packaging in an envelope shape, FIG. 22B is a side view of removing adhesive protector, and FIG. 22C is a side view of a sealed reversible packaging in an envelope shape; and

FIG. 23A is an outside closed view of an envelope shape with a first design, FIG. 23B is an outside open front view, FIG. 23C is an outside open back view, FIG. 23D is an inside open front view of an envelope shape with a second design, FIG. 23E is an inside open back view, FIG. 23F is an inside closed view, FIG. 23G is an inside open front view, and FIG. 23H is an inside open back view.

### DETAILED DESCRIPTION OF THE INVENTION

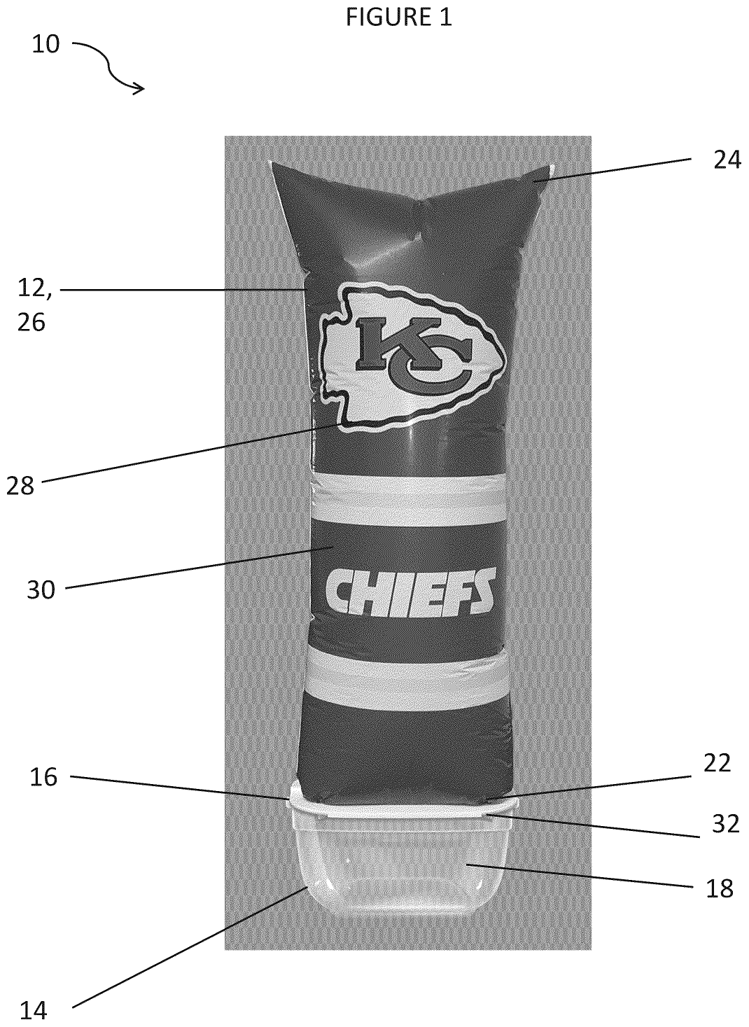

The present invention provides for a balloon, shown at 10 in the FIGURES and most generally in FIG. 1, that is inflatable by either cold or hot air flowing through an air vent when placed over the air vent or by a fan 70 operatively attached thereto. The balloon 10 includes an inflatable body 12 operatively attached to a base 14 on a proximal side 16 of the base 14, wherein the base 14 includes a cavity 18 for filling with items 20. The balloon 10 essentially integrates an inflatable body 12 with a base 14 containing items 20.

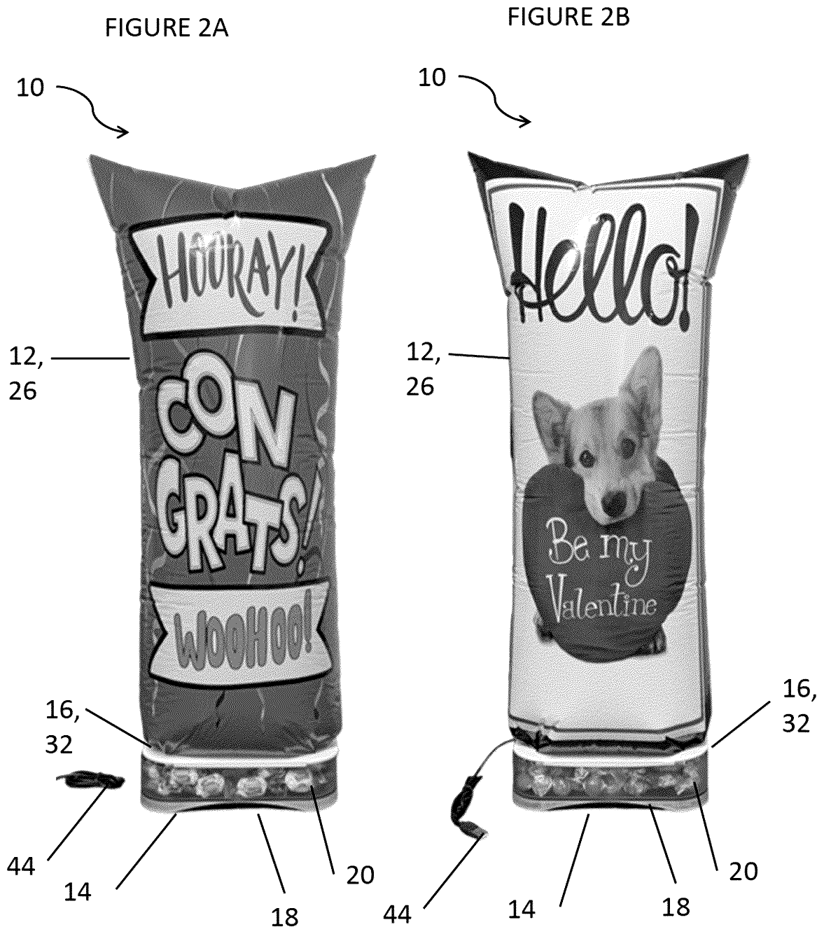

The inflatable body 12 is preferably a polyethylene bag having an open end 22 and a closed end 24. The inflatable body 14 can also be made of MYLAR® (DuPont, biaxially-oriented polyethylene terephthalate), or foil. The open end 22 is operatively attached to the base 14 with an air tight seal, such as with adhesive glue or any other suitable mechanism. In one embodiment, the inflatable body 12 is a lay-flat polyethylene bag 26, shown in FIGS. 1, 2A, and 2B. Alternatively, the inflatable body 12 is a gusseted polyethylene bag. The inflatable body 12 can include at least one vent that can essentially be a slit in the inflatable body 12 at any suitable location in order to let air gradually release from and flow through the balloon 10 while still allowing the inflatable body 12 to stand upright. Various sizes of the balloon 10 can have different numbers of vents. For example, a 20″ tall inflatable body 12 can have three vents or four vents, each ¼″ diameter in size, in a row near the closed end 24 of the inflatable body 12. A 26″ tall inflatable body 12 can have three vents or four vents, each ½″ diameter in size. A 30″ tall inflatable body 12 can have three vents or four vents, in any suitable diameter size.

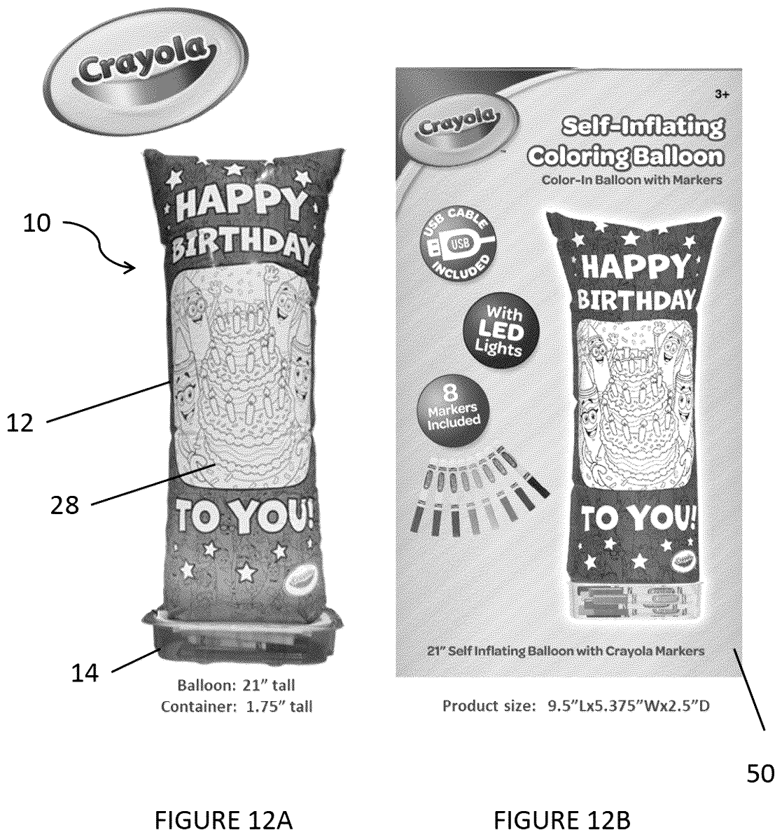

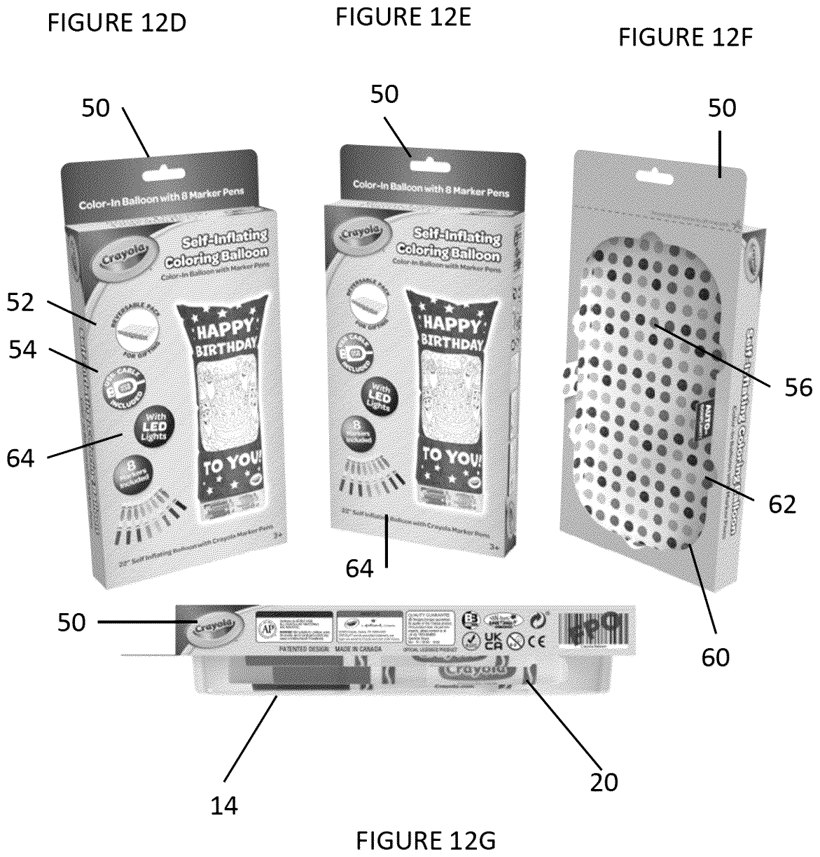

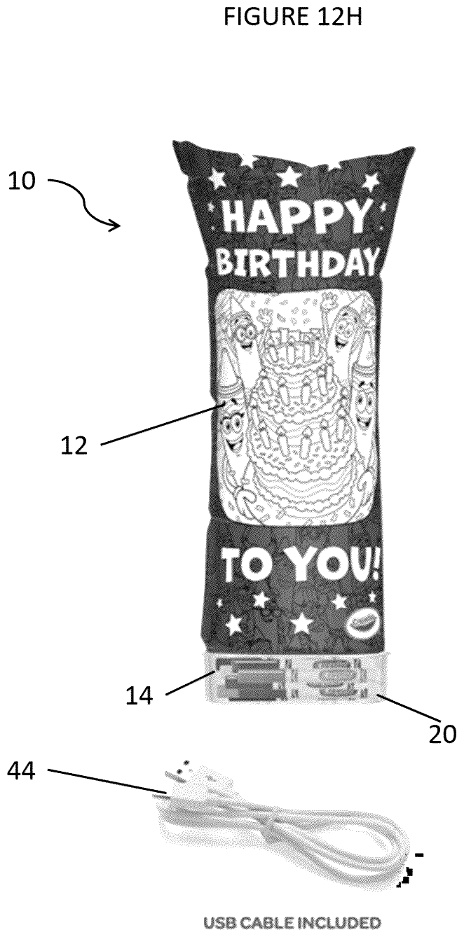

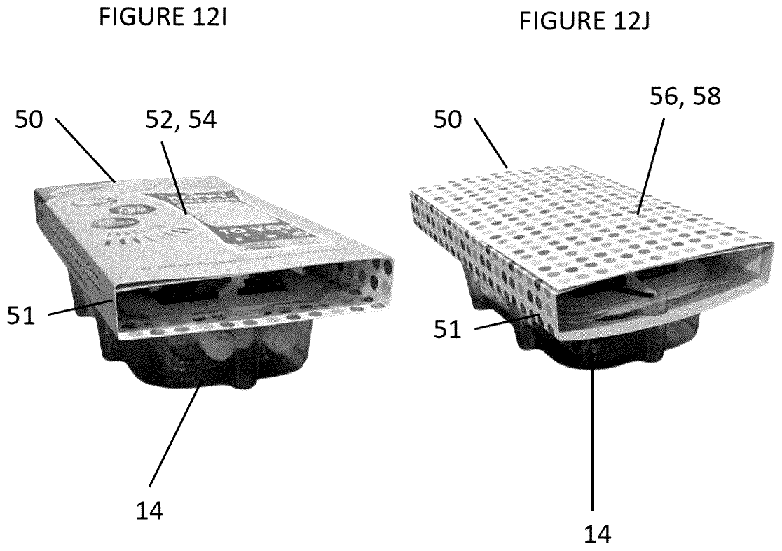

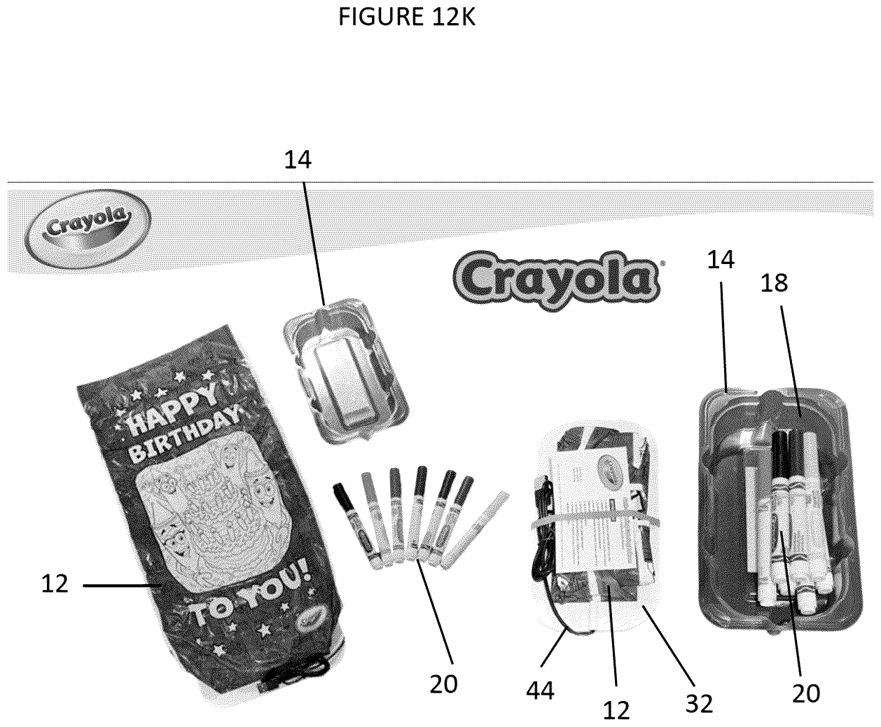

The inflatable body 12 further includes a design 28 imprinted on a front side 30 or on both the front side 30 and a back side. The design 28 can be the same on the front side 30 and back side, or different on each side. The design 28 can be a holiday greeting (FIG. 2B), congratulations (FIG. 2A), a birthday message (FIG. 5), a personal message, cartoon or other licensed characters, general celebratory designs, sports teams logos (FIG. 1), corporate designs, fundraiser designs, or promotional advertisements. The inflatable body 12 can also be any desired color (including metallic) and the design 28 can be any desired color. The inflatable body 12 can have at least a portion that can be colored in with a coloring device (such as markers (including washable markers and permanent markers), pens, paint, etc.), such as shown in FIG. 12A. Coatings can be added to the inflatable body 12 to allow color to adhere to the material of the inflatable body 12 when washable markers are used. The inflatable body 12 can further be a rectangular shape or a die cut shape.

The inflatable body 12 is operatively attached to the base 14 entirely at the open end 22 to the proximal side 16 of the base 14 by an adhesive glue or any other suitable mechanism. The proximal end 16 can be integral with the base 14 or be a removable and resealable lid 32. The lid 32 allows for access to the base 14 to access items 20 as well as to refill the base 14 with items 20. The lid 32 can alternatively cover a distal side 36. Any other seal can be included to seal items 20 within the cavity 18. A tamper proof seal covering the proximal side 16 or distal side 36 can also be included to keep food items 20 fresh which can be opened when access to the food items 20 is desired. Resealable lid 32 provides a seal with the base 14 that is strong enough to hold when air is flowing into the balloon 10.

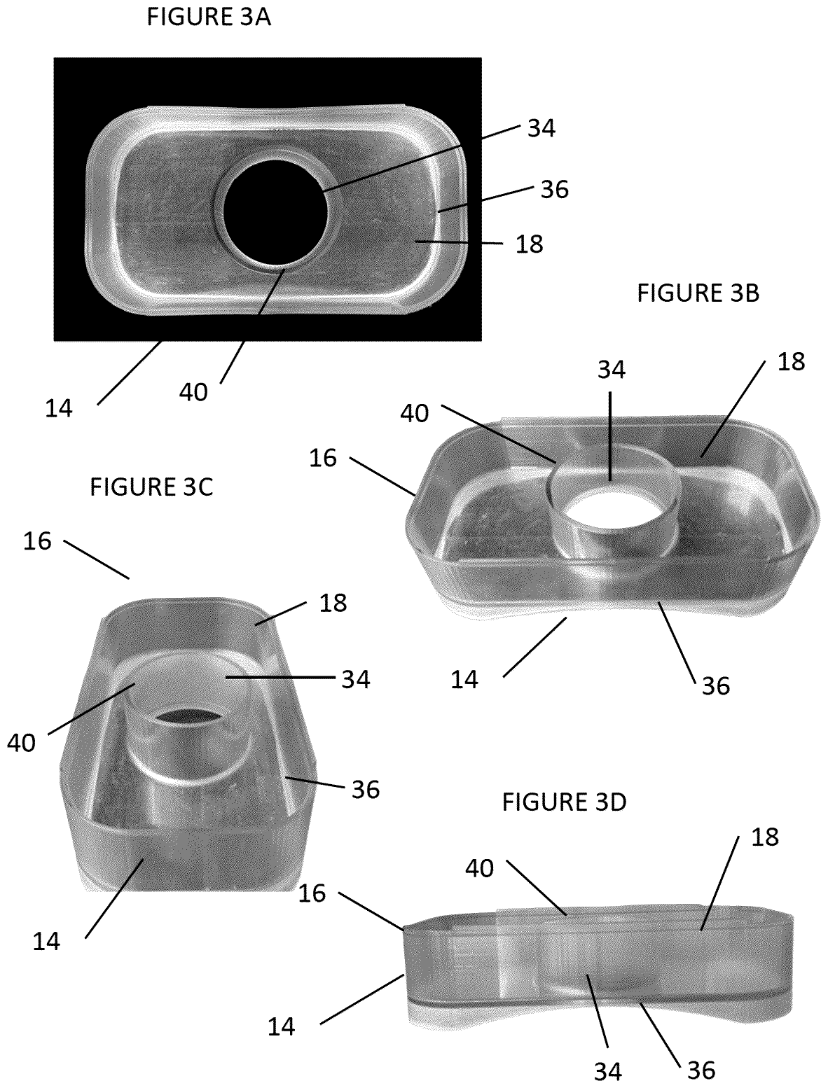

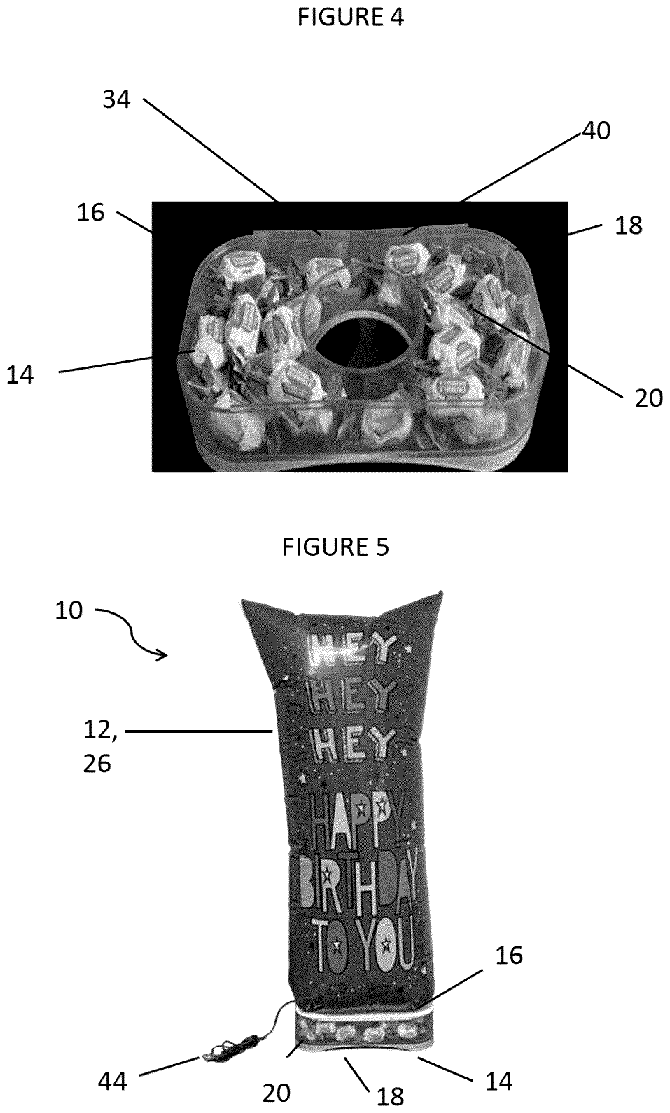

The base 14 is shown in detail in FIGS. 3A-3D and includes cavity 18 that allows the base 14 to be filled with items 20. The base 14 can be any suitable size to receive and hold items 20, and can come in multiple sizes such as small, medium, and large. The base 14 can include an opening 34 on the distal side 36 to receive air from a fan 70 or a standard air vent or any other air source. The proximal side 16/removable lid 32 can include a corresponding opening 38 (shown in FIG. 9) so that the air can flow into the inflatable body 12. The opening 34 can include a raised lip 40 that extends to the proximal side 16. This prevents items 20 from falling through the cavity 18 (such as in FIG. 4). Alternatively, if the items 20 are contained within a bag or multiple bags, they can be placed such that they allow air to flow through the cavity 18 without the need for a raised lip 40. Airflow through opening 34 is not restricted or is only minimally restricted when items 20 are in the cavity. Airflow also does not allow items 20 to blow into the inflatable body 12.

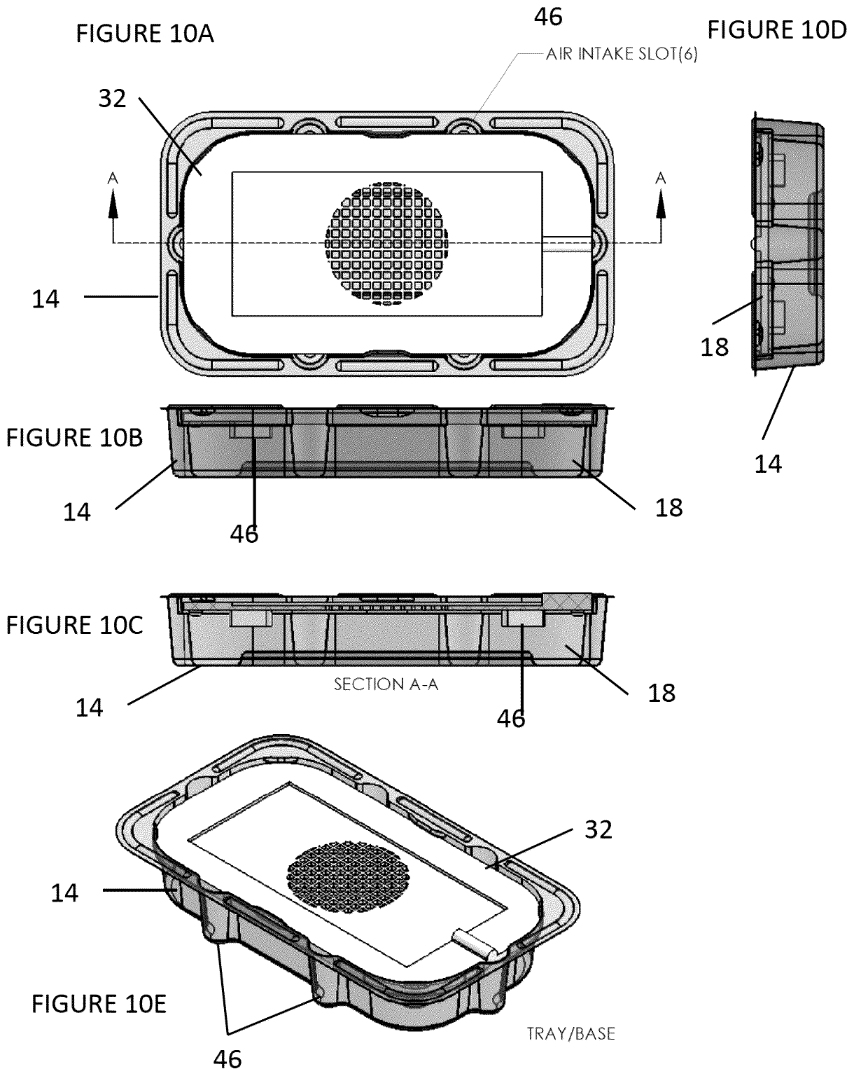

Alternatively, the base 14 does not require the opening 34 to receive airflow from the air source of a fan 70 or air vent, but can instead include a plurality of air intake slots 46 around the base 14. Six air intake slots 46 are shown in FIGS. 10A-10E. With this design, the base 14 can be completely filled with items 20 without the need to keep items 20 away from an opening 34 for air. Other aspects of the design can be the same.

The base 14 is made of a hard plastic such as thermoformed or injection molded plastic. The plastic can be food grade or non-food grade. Examples of plastics that can be used include, but are not limited to, polyethylene terephthalate (PET), recycled polyethylene terephthalate (rPET), polyactic acid (PLA), polyvinyl chloride (PVC), amorphous polyethylene terephthalate (APET), or electro static dissipation plastics (antistatic, static-dissipative, or conductive plastics). Preferably, base 14 is see through or semi-opaque so that the items 20 can be viewed therein. The thickness of the base 14 can vary based on the material used and allows for the base 14 to be protected from crushing.

The base 14 can be made in various shapes such as a gift box, helmet, racing car, shoes, character, heart, or any other suitable shape. The shape can correspond to the design 28 on the inflatable body 12 or not be related.

The items 20 can include, but are not limited to, food items such as candy, chocolates, cookies, nuts, or snacks, t-shirts, socks, wallets, belts, jewelry, perfume, gifts, golf balls, golf tees, games, construction blocks (such as LEGOS®), sports cards, art supplies, markers or stickers for do-it-yourself kits, or any other promotional items. The individual items 20 can be wrapped or sealed or unwrapped or unsealed and placed within the cavity 18. The items 20 can also be in a resealable pouch in order to keep food items 20 fresh. The balloon 10 can be sold with an empty cavity 28 that can be filled by a user once purchased, or the balloon 10 can already include items 20 within the cavity 28 at time of purchase.

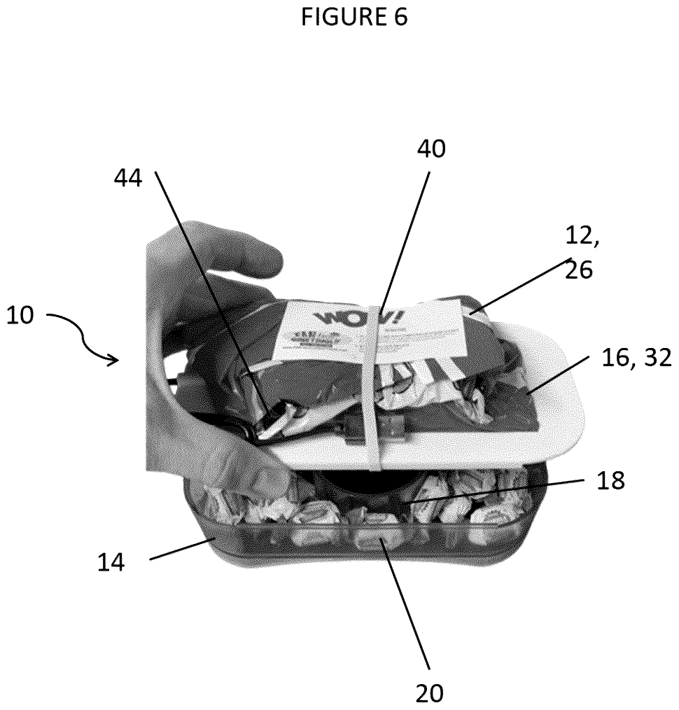

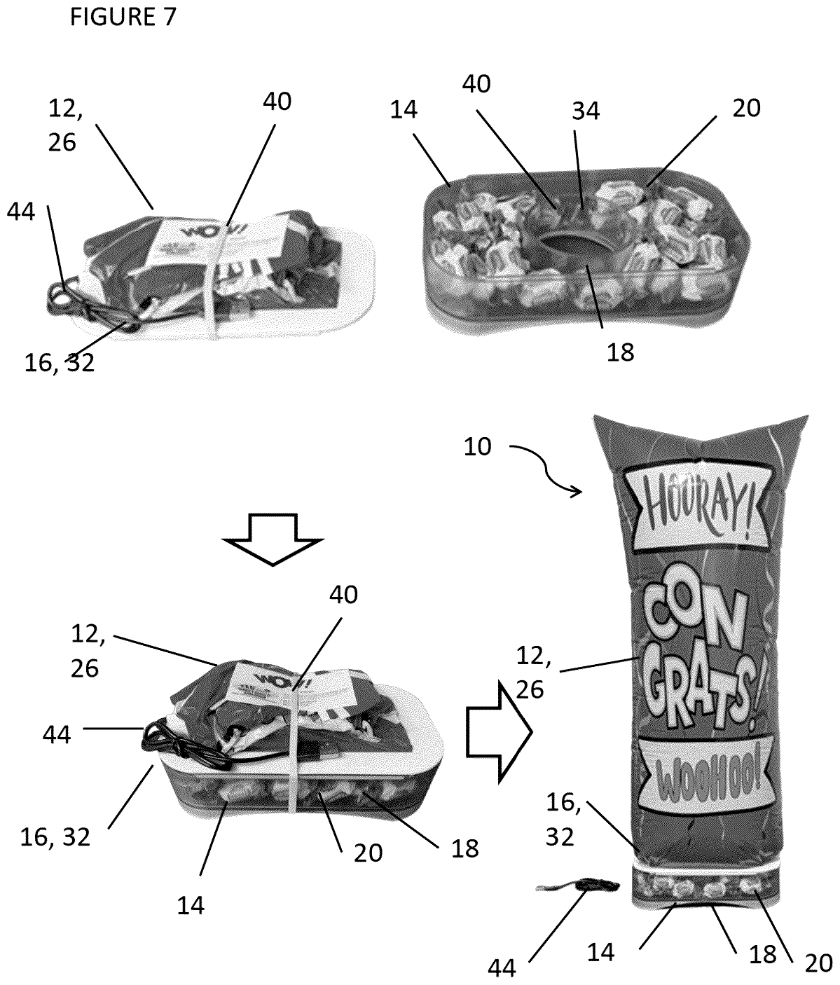

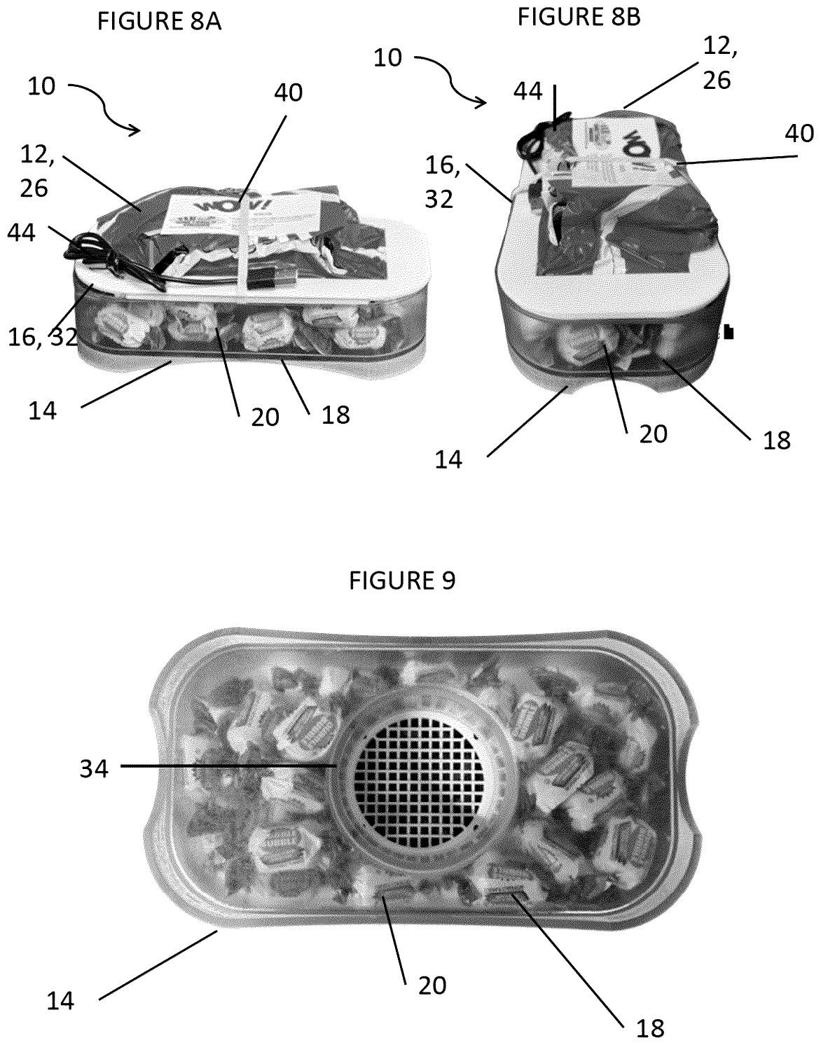

FIG. 6 shows the proximal side/removable lid 32 being placed on the base 14. The inflatable body 12 can be folded and secured with a securing mechanism 42 until ready for use, such as a rubber band, tie, or hook and loop mechanism. The folding can obscure or hide the design 28 to provide a surprise when inflated. FIGS. 8A and 8B show the removable lid 32 placed on the base 14. The securing mechanism 42 can also wrap around the base 14 as shown in FIG. 7.

FIG. 7 shows assembly of the balloon 10. The inflatable body 12 is folded and secured to the proximal side 16/removable lid 32 with securing mechanism 42, the base 14 is filled with items 20, and the removable lid 32 is secured to the base 14. The balloon 10 is placed in any desired location to display (over an air vent or through use of a fan 70), the securing mechanism 42 is removed, and the inflatable body 12 inflates and displays the design 28.

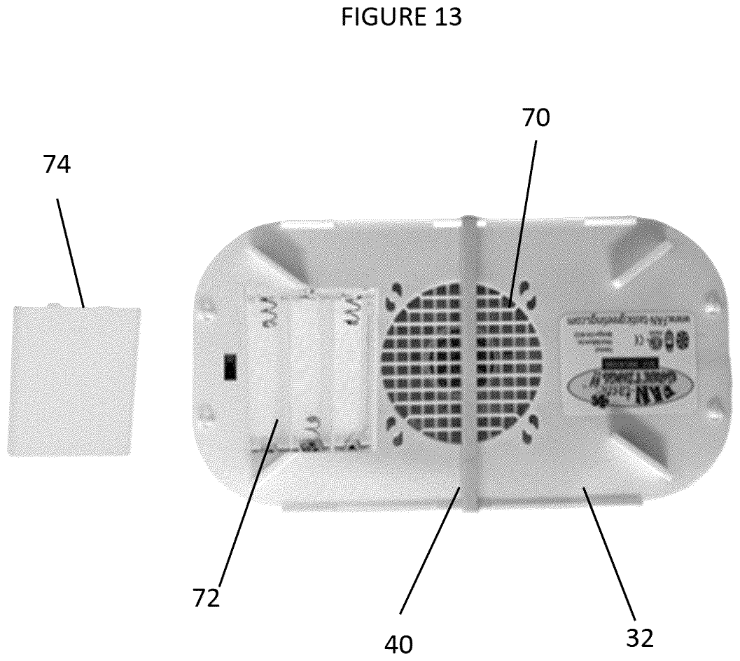

When the balloon 10 uses a fan 70 to provide air to the inflatable body 12, any necessary electronics can be included such as a power cord 44. The power cord 44 can be a USB power cord (including type A, type B, type C (compatible with Nexus 5X/6P, Nokia N1 tablet, One plus 3/2 LG G5), mini USB (compatible with MP3/4 players, GoPro, digital cameras), and micro USB (compatible with Android phones, BLUETOOTH® headphones, power banks), a lightning power cord (8 pins compatible with iPhone X/8/7/7plus/6s/6s plus/SE/5s/4c/5, iPad Pro Air mini), an AC/DC power cord, a cord that connects to a battery (such as a 9V battery) or battery pack, or any other suitable types of power cords. The power cord 44 can therefore, depending on type, be plugged in to a power source such as desktop computers, laptops, tablets, smart phones, or wall outlets. An on/off switch can also be included with an internal battery (battery pack of AA (such as 3 AA batteries), AAA (such as 2 AAA batteries), or coin cells/lithium ion batteries) if a power cord 44 is not included for operating the battery. The removable lid 32 (or any other appropriate part of the base 14) can include an internal molded slot 72 shaped for receiving any battery as well as a removable cover 74 as shown in FIG. 13. The securing mechanism 42 can also secure the power cord 44 for shipping or when the balloon 10 is not in use. The fan 70 can be located and operatively attached at the distal side 36 of the base 14 over the cavity 18, or alternatively at the proximal side 16.

The balloon 10 can further include LED light strips attached any suitable place within the base 14 that are also powered by the power cord 44.

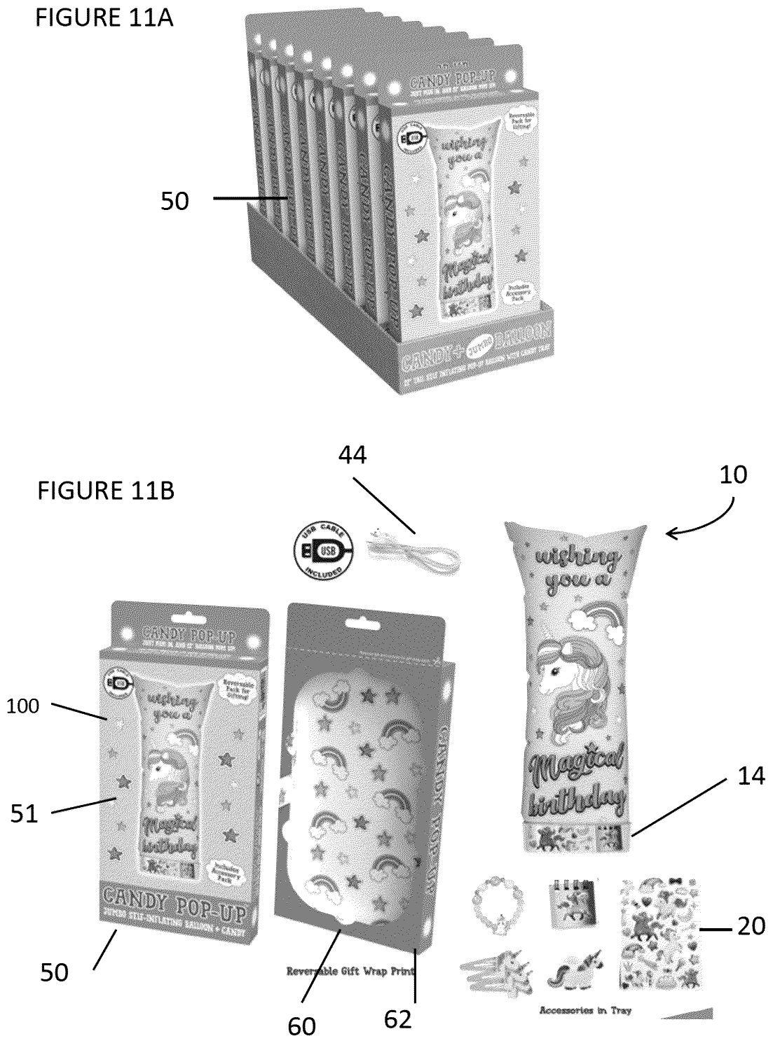

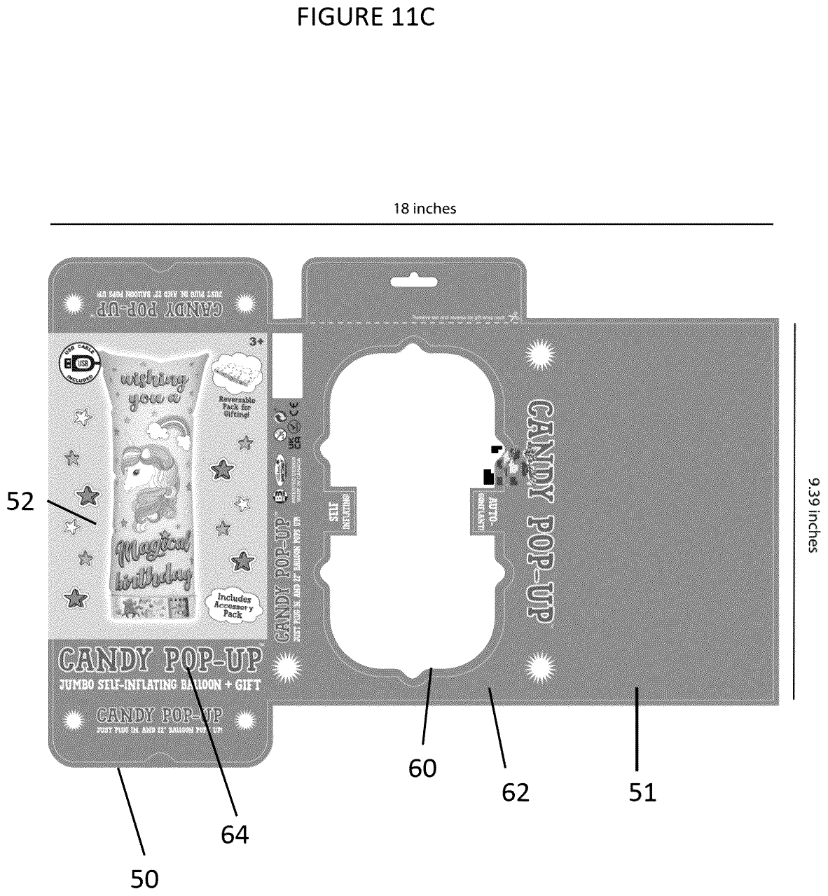

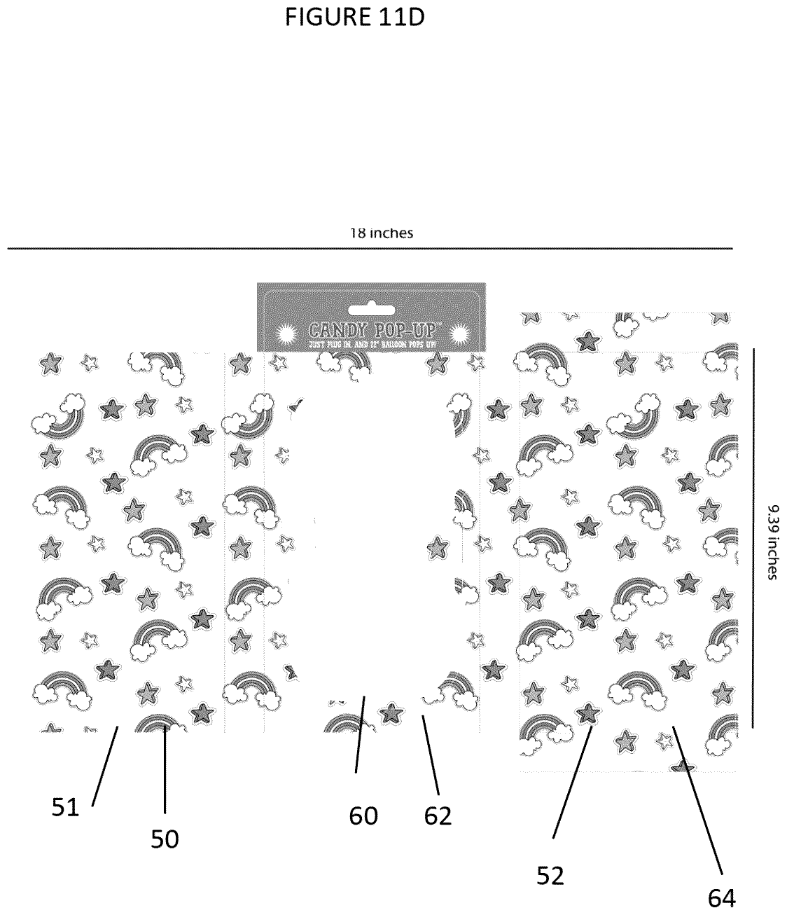

The balloon 10 can be contained within packaging 50 such as a plastic sleeve or box (made of paper or cardboard) for shipping or display in stores. The packaging 50 can include various designs related to the balloon 10, and can include a first design 52 on a first side 54 (such as showing the contents of the packaging 50 or identifying product information), and a second design 56 on a second side 58 (such as a gift wrap design). Essentially, the packaging 50 is reversible so that the first design 52 can be shown in a store to display and sell the balloon 10 and the second design 56 can be used if a user wants to give the balloon 10 as a gift. The packaging 50 can include a cut out 60 on a distal side 62 through which the base 14 fits such that the base 14 protrudes through the cut out 60, while the inflatable body 12 remains within the packaging 50 under the proximal side 64. Therefore, when the proximal side 64 is opened, the balloon 10 can inflate. The packaging 50 can be secured to the base 14 by any suitable mechanism, such as tabs that fit in or around the removable lid 32 or a portion of the base 14. FIG. 11A shows a plurality of balloons 10 in packaging 50 for display. FIG. 11B shows an exploded view of contents of the packaging 50, including the packaging 50 with views of the proximal 64 and distal 62 sides, balloon 10, with base 14 and items 20. FIG. 11C shows the packaging 50 flat with exemplary dimensions and a first design 52. FIG. 11D shows the packaging 50 flat with exemplary dimensions and a second design 56. The packaging 50 can be folded into shape surrounding the inflatable body 12 and secured with any suitable adhesive (such as pressure sensitive adhesive). A user can turn the packaging 50 to the second design 56 and secure the packaging 50 themselves with the adhesive.

FIG. 12B shows a second example of a design of packaging 50 with representative dimensions. FIGS. 12-12G show the packaging 50 from different angles. FIG. 12H shows the balloon 10 with the base 14 and a power cord 44 as the contents of the packaging 50. FIG. 12I shows a first design 52 on proximal side 64 of packaging 50 and FIG. 12J shows a second design 56 on distal side 62 of packaging 50. FIGS. 12I-12J also show the base 14 protruding through the cut out 60, with the inflatable body 12 secured within the packaging 50. FIG. 12K shows a blown apart view of the contents of the package 50, including the inflatable body 12, base 14, items 20, as well as the inflatable body 12 and power cord 44 secured to the removable lid 32 and the items 20 placed within the cavity 18 of base 14.

The present invention also provides for a method of using the balloon 10, by placing the balloon 10 at a display location, flowing air through the inflatable body 12, inflating the inflatable body 12, and providing access to items 20 within the cavity 18. The display location can be over an air vent or any other suitable location where the base 14 can rest on a surface when the fan 70 is used as an air source and plugged in with the power cord 44. The method can further include removing the securing mechanism 42 so that the inflatable body 12 can inflate. Inflating the inflatable body 12 further includes displaying the design 28. Air can also flow out of any vents in the inflatable body 12. Access to the items 20 can be provided through opening the removable lid 32. Any other seal such as a tamper proof seal can be opened in order to access the items 20. Items 20 can also be resealed in a resealable pouch especially if they are food items. The method can further include refilling the items 20 in the cavity 18. The method can further include a user securing packaging 50 around the balloon 10 showing a first design 52 or a second design 56 to provide the balloon 10 as a gift. The method can also include a user applying color to the inflatable body 12 before being inflated by laying the inflatable body 12 on a flat surface and coloring with a coloring device as described above. Any LED lights on the balloon 10 can be illuminated when powered with the power cord 44.

The present invention also generally provides for reversible packaging 50, including a packaging body 51 having a first design 52 on a first side 54, and a second design 56 on a second side 58, as well as preferably having a sealing mechanism for sealing the reversible packaging around a product. The packaging body 51 is essentially reversible. The first design 52 can be, but is not limited to, showing the contents of the packaging 50, any information that is commercially required or regulatory required, display for a sales shelf, packaging for shipping, and/or any safety information. The second design 58 is preferably gift wrap, but can also be return packaging labeled with return postage, or combinations thereof. When the second design 58 is a gift wrap design, it can be a holiday design, a congratulatory design, a birthday design, a personal message design, cartoon or other licensed character design, a general celebratory design, a sports teams logo, a corporate design, a fundraiser design, or a promotional advertisement.

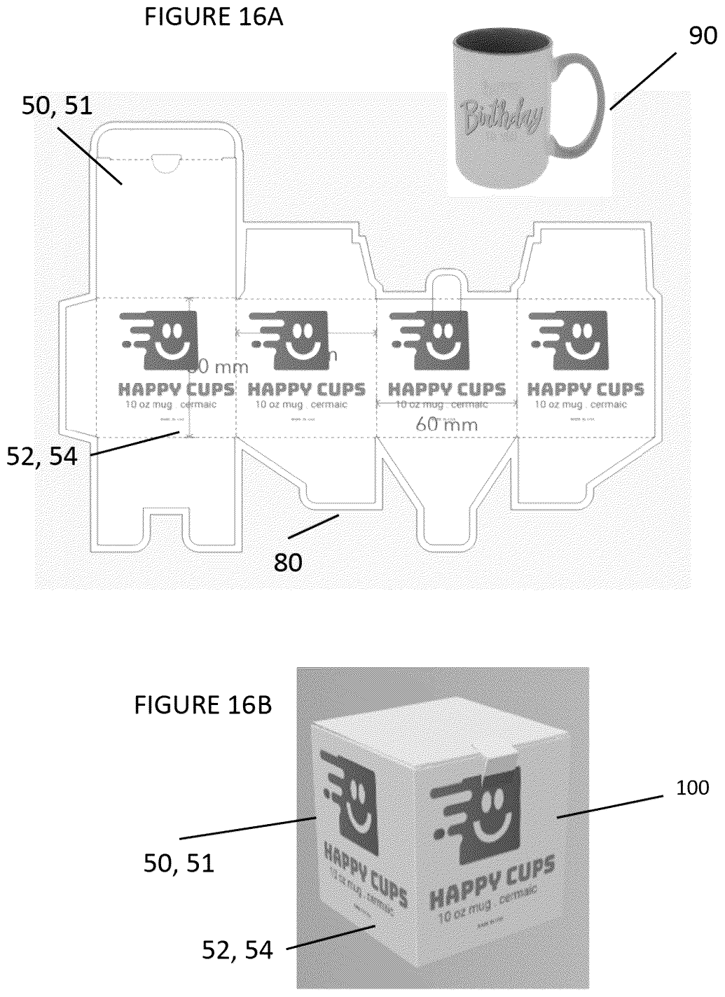

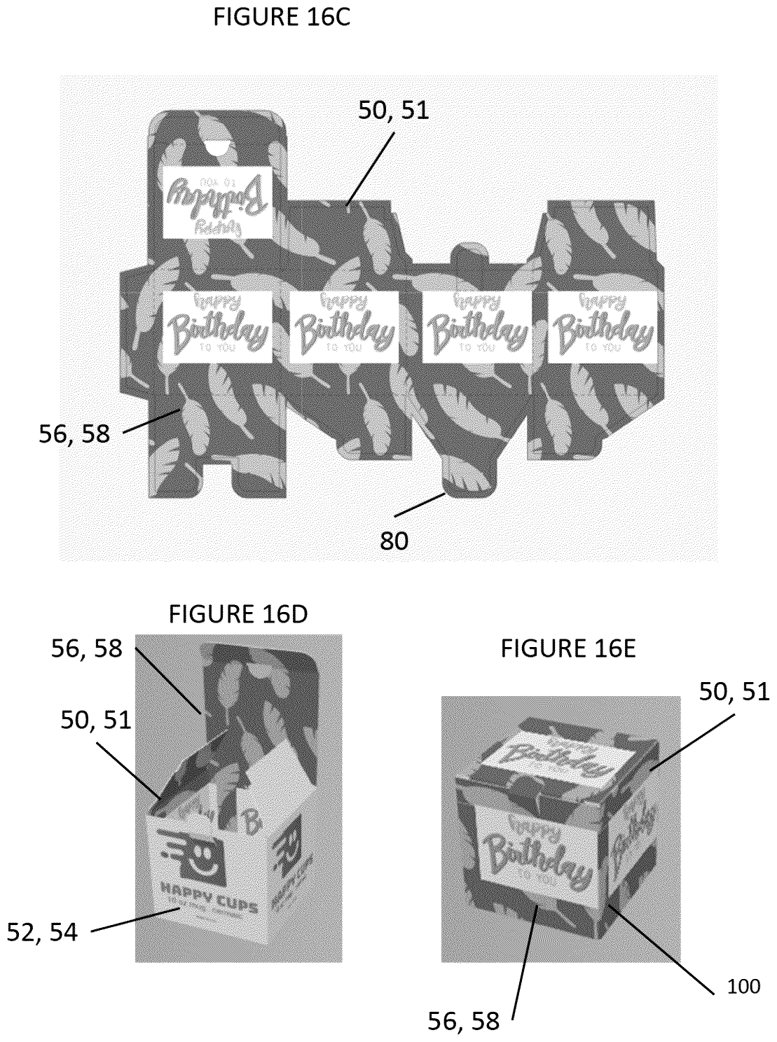

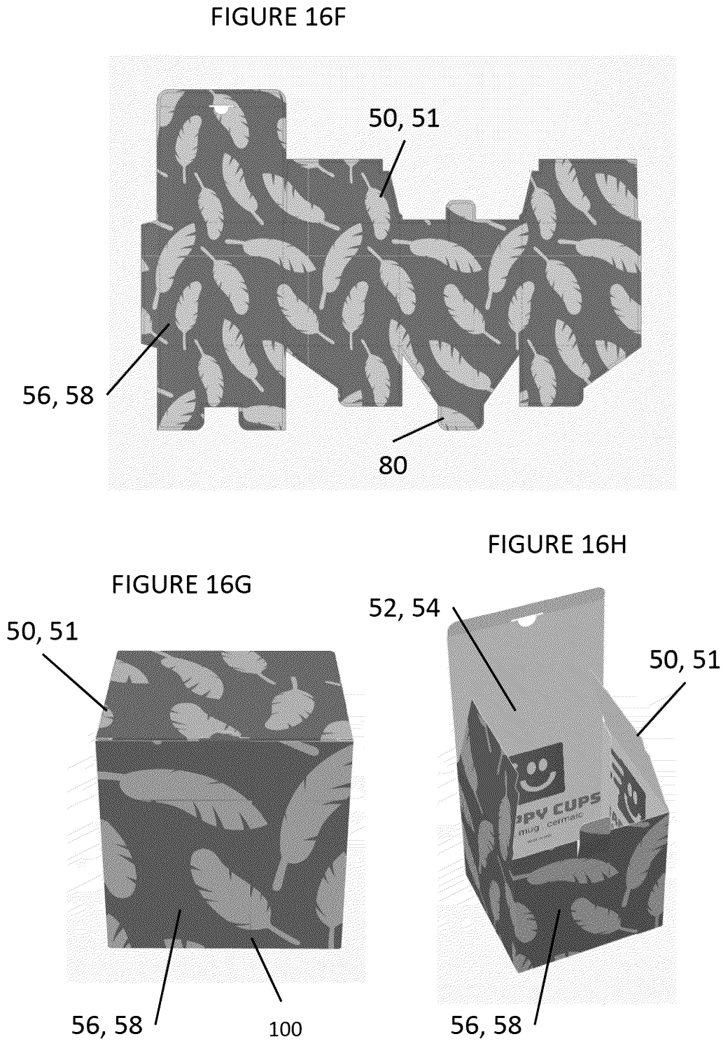

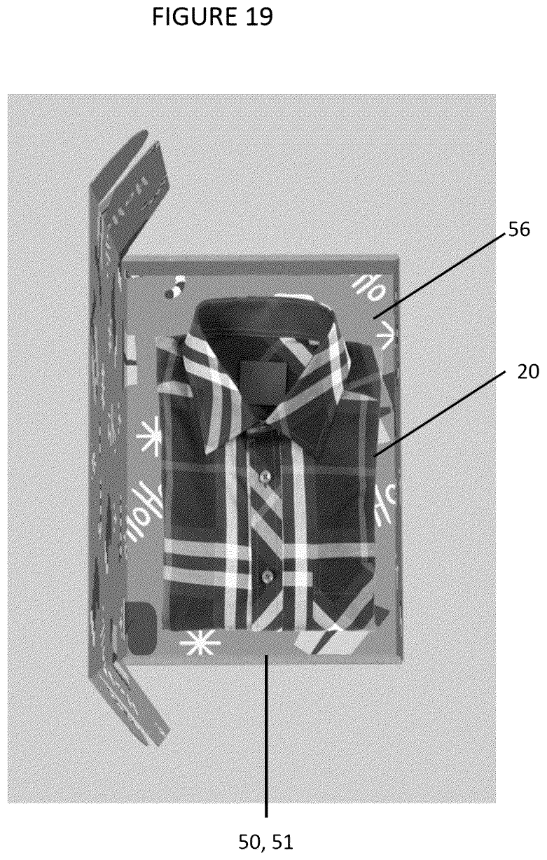

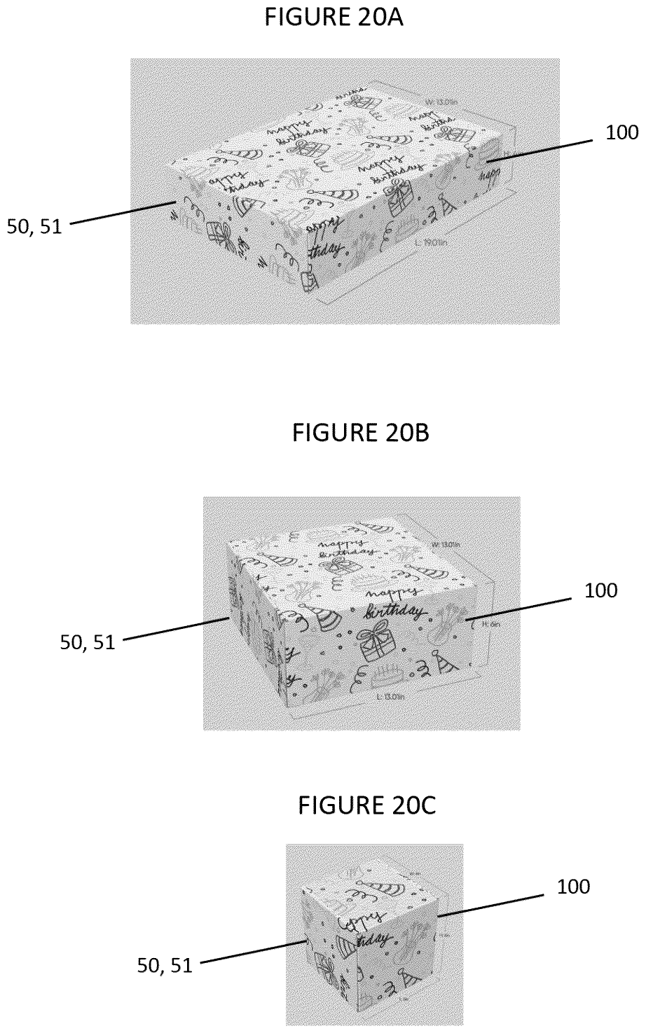

The reversible packaging 50 allows a user to buy a product at a store and reverse its packaging to a colorful and celebratory design without having to buy gift wrap since the reversible packaging 50 is the gift wrap itself. The reversible packaging 50 is not limited to use with the balloon 10 described above and can be used to contain any product or item 20, and therefore is sized according to the product it contains. FIGS. 20A-20C show different sized box shapes 100 such as a large rectangle (FIG. 20A), a small rectangle (FIG. 20B), and a cube (FIG. 20C). The product/item 20 can be for example a toy, perfume, a frozen cake, candy, jewelry, a mug 90 (shown in FIG. 16A), clothing (such as in FIG. 19) or any other product that is contained within a box. The reversible packaging 50 can be made of paper, cardboard, kraft paper, polyethylene, or other suitable materials. The reversible packaging 50 can be formed in any box shape 100 or envelope (such as mailer envelopes) shape 102, as well as a shopping bag. When in a shopping bag form, the reversible packaging 50 can omit the sealing mechanism as the shopping bag can be left open on one side and filled with tissue paper when giving as a gift.

The reversible packaging 50 can include any of the features described above, such as adhesive or other sealing mechanism (such as glue, hook and loop). The reversible packaging 50 can include a first sealing mechanism for sealing the packaging body 51 with the first design 52 placed on any suitable location (such as edges of the first side 54). The reversible packaging 50 can include a second sealing mechanism for securing the second design around a product contained within the packaging body 51. The second sealing mechanism can also be located at any suitable location on the second side 58 (such as edges of the second side 58). A plurality of tabs 80 and corresponding receiving slots 82 can be included on any part of the packaging body 51 for ease of sealing and forming the reversible packaging 50 into a shape to contain a product (and can be used instead or in addition to the other sealing mechanisms described above). The shape of the reversible packaging 50 when showing the first design 52 can be the same or a different shape when showing the second design 56. The reversible packaging 50 can further include perforations to allow the packaging body 51 to be broken down into a smaller size when showing the second design 56.

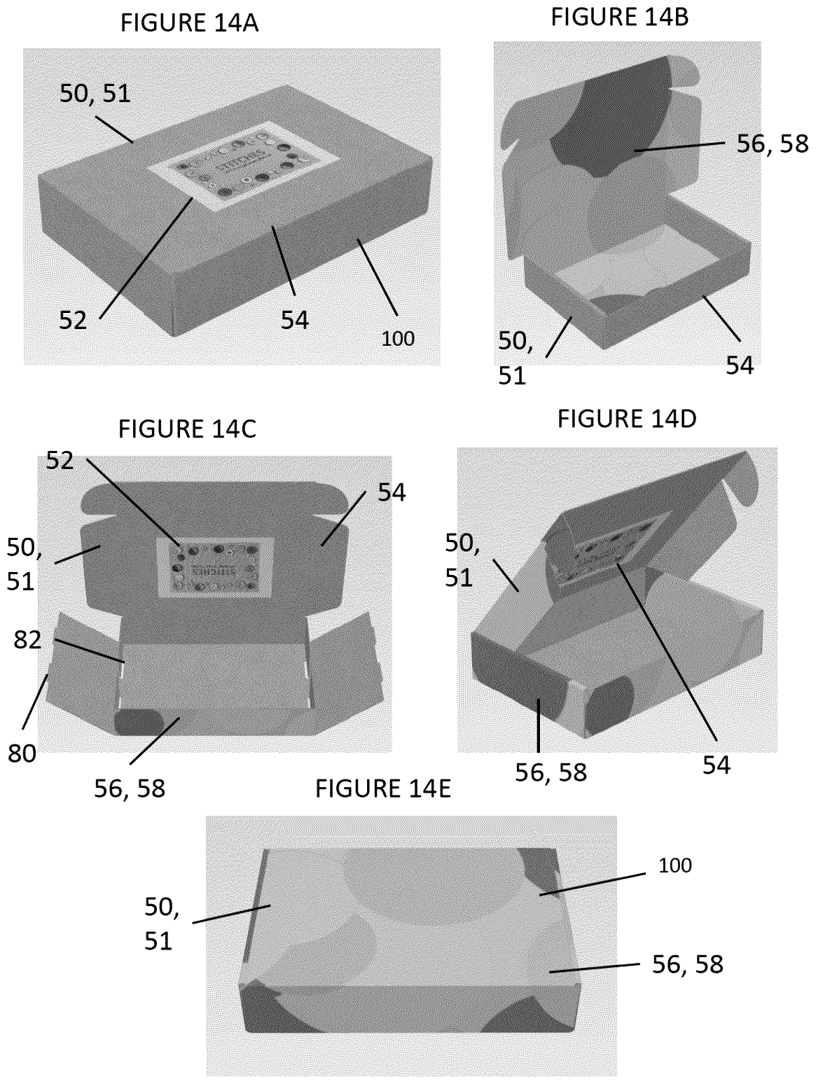

The reversible packaging 50 is further shown with different examples in FIGS. 14A-14E, 15A-15J, and 16A-16H. FIG. 14A shows the first side 54 with a first design 52 (such as a product identifier). FIG. 14B shows the reversible packaging 50 opened to reveal a second design 56 inside on a second side 58. The reversible packaging 50 can be unfolded to refold and secure showing the second design 56 as in FIG. 14C. FIG. 14D shows the second side 58, and FIGURE shows the second side 58 (with a gift wrap design) as folded in a box shape.

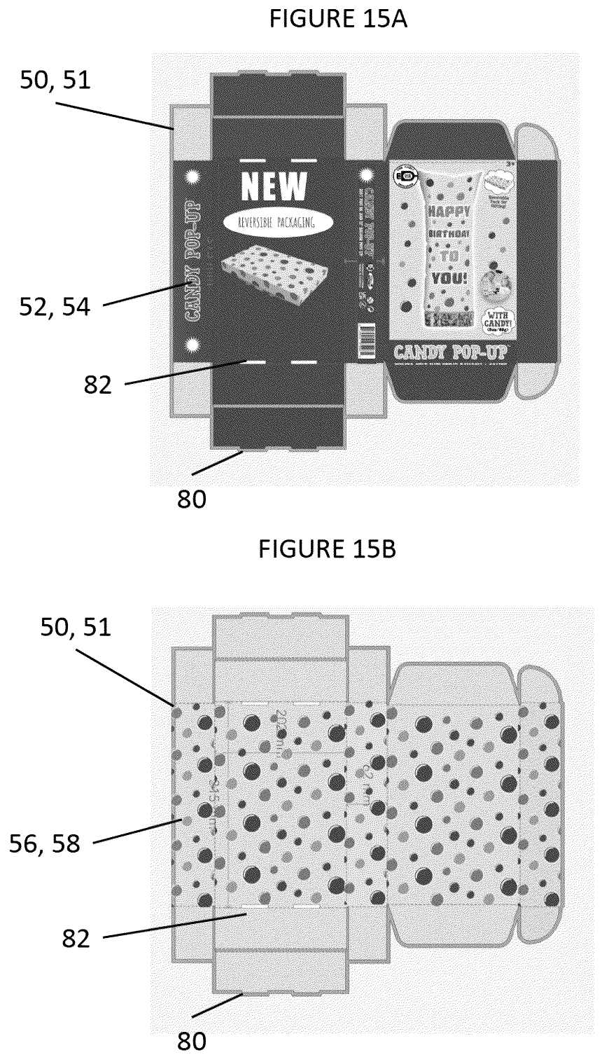

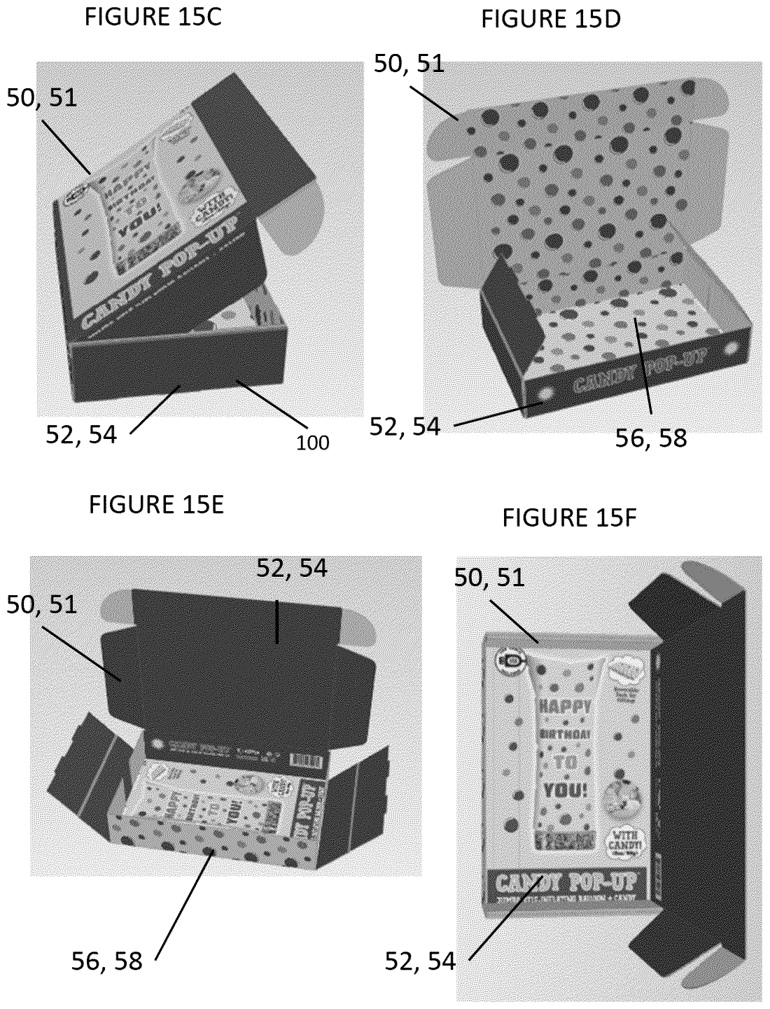

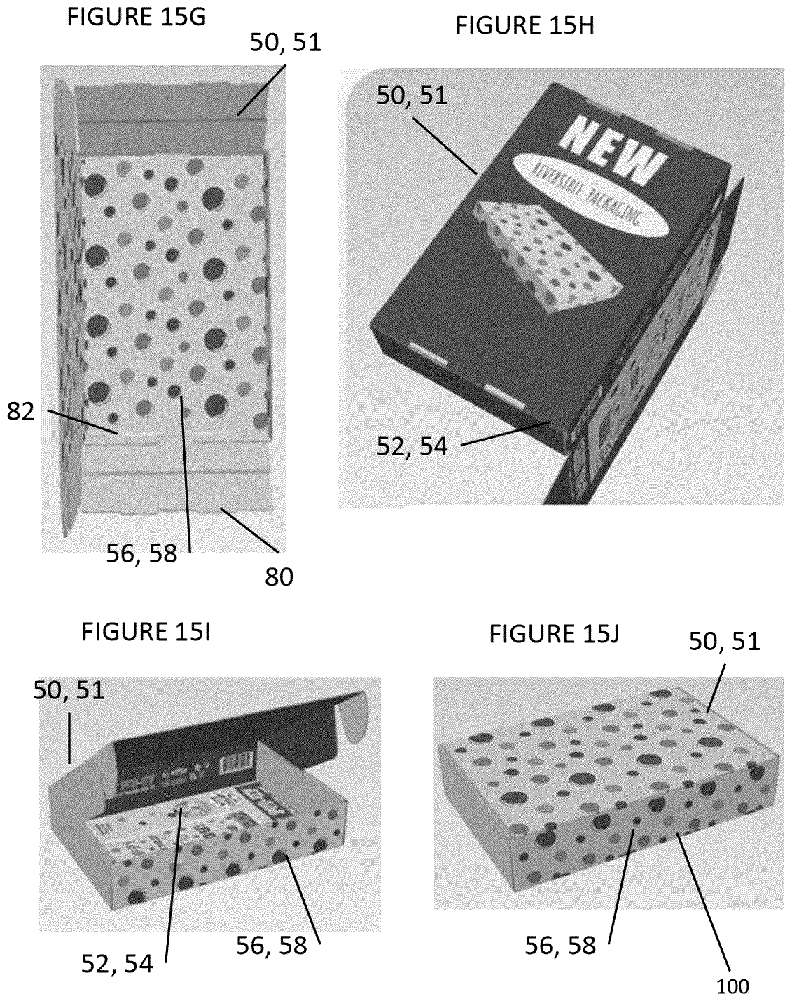

FIG. 15A shows a first side 54 of reversible packaging 50 with a product identifying first design 52. FIG. 15B shows a second side 58 of reversible packaging 50 with a gift wrap second design 56. FIG. 15C and 15D show a box 100 using a first side 54 of reversible packaging 50 and the second design 56 can be seen inside. FIG. 15E shows the reversible packaging 50 unfolded to refold showing a second design 56. FIG. 15F is a top view of the reversible packaging 50 with a first design 52 inside. FIG. 15G is a top view of reversible packaging 50 showing a second design 56 inside, and tabs on sides can be folded to reform the box 100. FIG. 15H is a bottom view of reversible packaging 50 showing a first side 54. FIG. 15I shows the second side 58 of reversible packaging 50 now formed in a box 100, and FIG. 15J shows the second side 58 with the second design 56 as the box 100 is closed.

FIG. 16A shows a first side 54 of reversible packaging 50 for a mug 90 unfolded to show a first design 52 of identifying product information. FIG. 16B shows the first side 54 as folded to form a box 100. FIG. 16C shows a second side 58 of the reversible packaging 50 unfolded with a celebratory greeting. FIG. 16D shows the first side 54 and the second design 56 can be seen inside. FIG. 16E shows the second side 58 as formed in a box 100. FIG. 16F shows the second side 58 with just a gift wrap design without a celebratory greeting. FIG. 16G shows the second side 58 formed in a box 100, and FIG. 16H show the second side 58 showing the first design 52 inside the box 100.

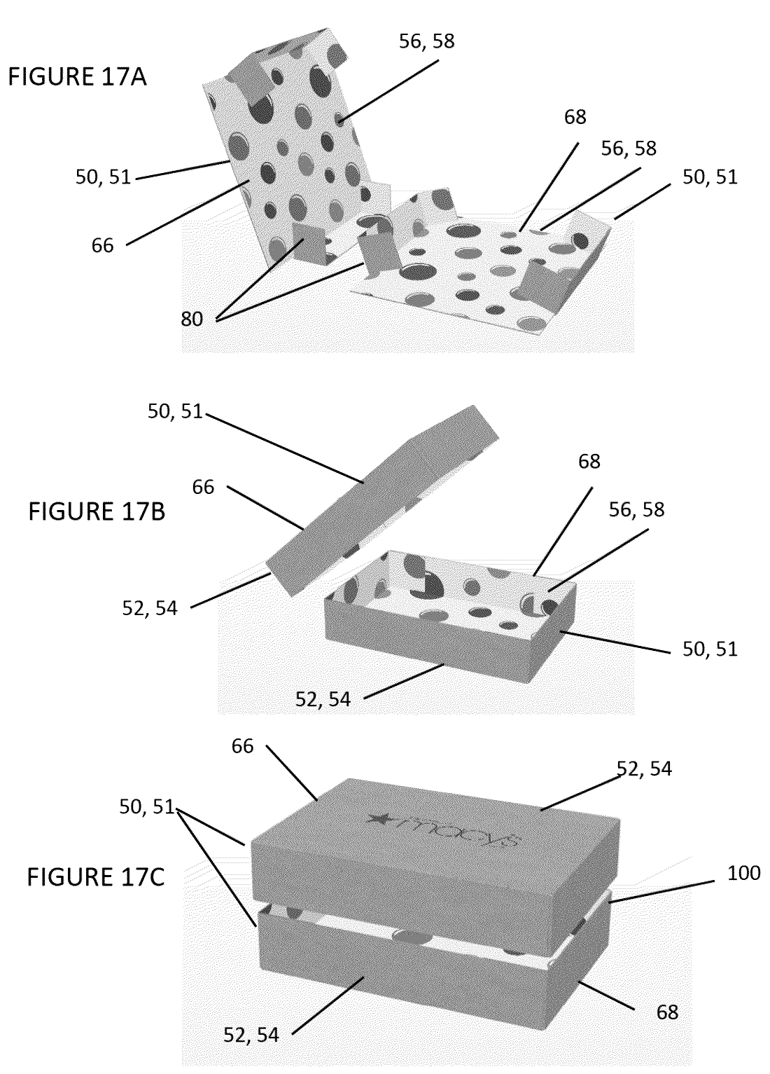

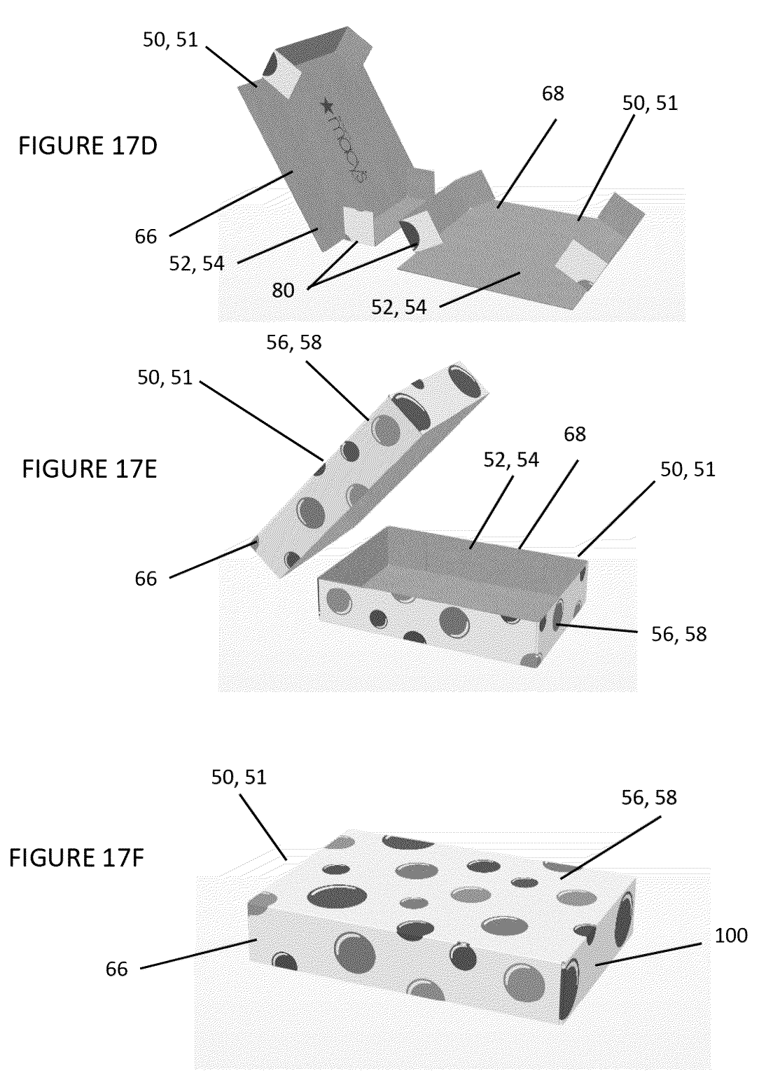

FIGS. 17A-17F show reversible packaging 50 wherein the packaging body 51 is not a single unitary piece but rather is separated into a top body 66 and bottom body 68 that can be secured together such that the top body 66 fits over the bottom body 68 to form a box. In other words, the top body 66 acts as a lid and the bottom body 68 acts as a tray to contain the item 20. The top body 66 and bottom body 68 can have a double-wall structure, which provides a strong and durable design. Inserts can be included within the bottom body 68 to secure items 20 in place. This embodiment can be useful to have the top body 66 and bottom body 68 used in a display setting, no need for glue to be used because the parts are reversibly locking, it has easy assembly, compact storage because it can be stored flat, it can be used with a box sleeve, and it can easily be used with shoes to allow a shoe box to convert to a gift box. The top body 66 and bottom body 68 each have a first side 54 with a first design 52 and a second side 58 with a second design 56. FIGS. 17A-17C show the reversible packaging 50 being formed in a box wherein the first design 52 is showing on the outside and the second design 56 is on the inside, such as when used for shipping. The user can disassemble the top body 66 and the bottom body 68 showing the first design 52, and reassemble the top body 66 and bottom body 68 to show the second design 56. FIGS. 17D-17F show the reversible packaging 50 being formed in a box wherein the second design 56 is showing on the outside and the first design 52 is on the inside, such as when used for a gift. The packaging body 51 includes any necessary tabs 80, receiving slots 82, and/or adhesive in order to secure the packaging body 51 in a box shape or for sealing for shipping or giving a gift.

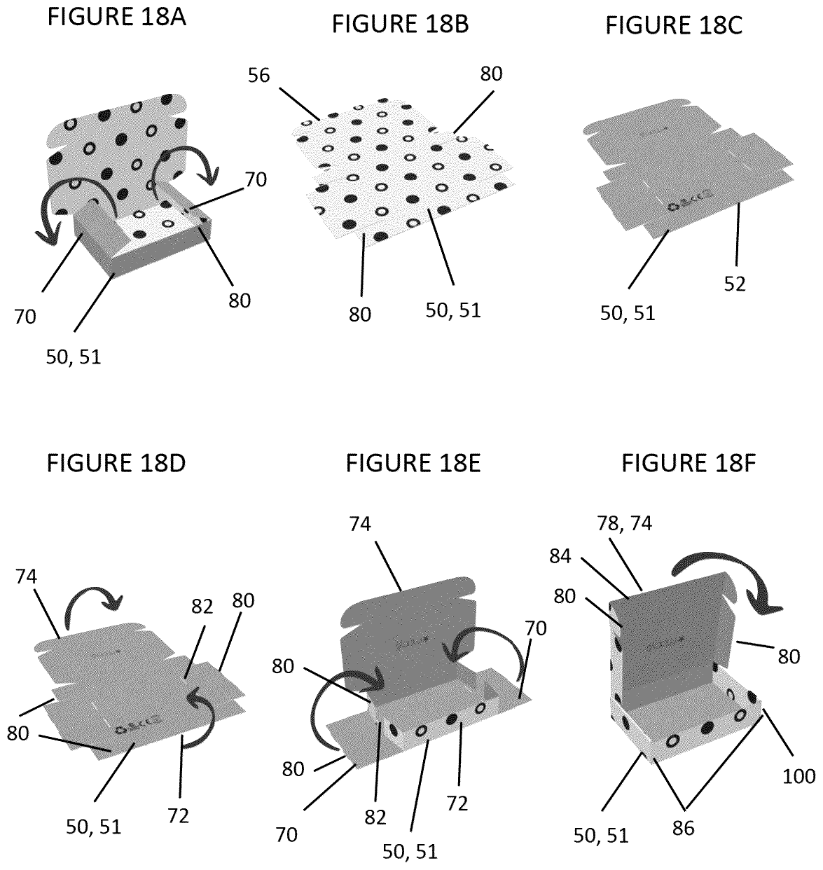

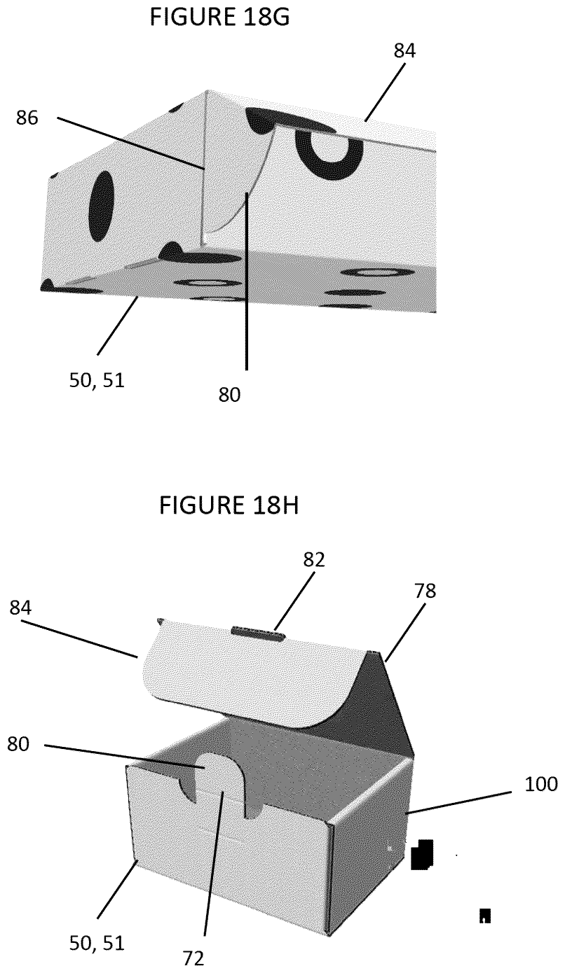

FIGS. 18A-18F show general directions for reversing the design of reversible packaging 50. When a user has received a package, in FIG. 18A, the first step is that the user opens the package and unfolds side panels 70 up and over front and back tabs 80. In a second step, in FIG. 18B, the user completely unfolds the tabs 80 and lays the reversible packaging 50 flat with the second design 56 (gift design) showing. In a third step, in FIG. 18C, the user flips the reversible packaging 50 over such that the first design 52 is showing. In a fourth step, in FIG. 18D, the user folds a front panel 72 and back panel 74 upward and folds tabs 80 inward towards the center of the reversible packaging 50. In a fifth step, in FIG. 18E, the user folds the side panels 70 of the reversible packaging 50 up and over the tabs 80 while keeping the front panel 72 and back panel 74 in place. Tabs 80 on the side panels 70 are tucked into the receiving slots 82 on a bottom side 76 of the reversible packaging which locks them into place. In a sixth step, in FIG. 18F, the user closes the reversible packaging 50 box by folding a lid 78 which is formed with the back panel 74 over, folding tabs 80 inward and folding a front flap 84 downward and tucking tabs 80 into slots 86 formed by the side panels 70. FIG. 18G shows a close up of tucking tabs 80 into slots 86. FIG. 18H shows an alternative design for the lid 78 with front flap 84 including a receiving slot 82 for a tab 80 on front panel 72. The lid 78 is folded down and the front flap 84 is tucked inside the box, then the tab 80 is inserted in the receiving slot 82 on the front flap 84 to lock the lid 78 in place. The user can further apply adhesive if needed. In the final form, the reversible packaging 50 is showing the second design 56. This method can be performed again if the user needs to send the product in the reversible packaging 50 back to a store in with the shipping design (first design 52 showing).

FIG. 19 shows an example of an item 20 (a shirt) inside the reversible packaging 50 that has just been received by the user and therefore the second design 56 is in the inside of the reversible packaging 50.

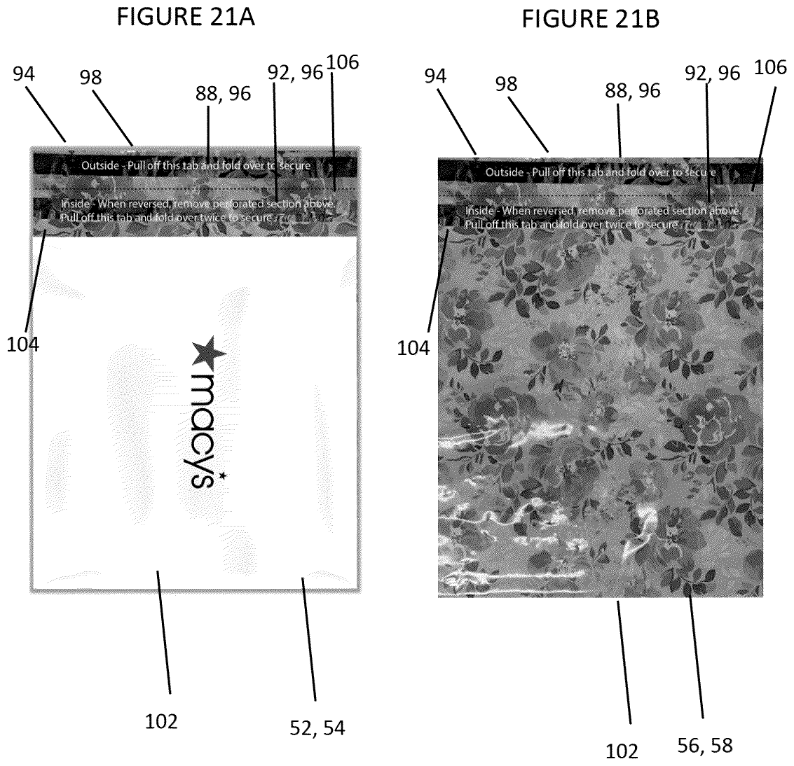

FIGS. 21A-21B show the reversible packaging 50 in an envelope shape 102. The packaging body 51 can be a flat lay or gusset 2.5 mil poly mailer, which is lightweight and includes adhesive strips which the user/shipper can expose to fold over and seal the envelope. The envelope 102 can include an anti-static metallic liner for safety and comfort, the materials can be recyclable, moisture-resistant, and durable to provide optimum protection against moisture, punctures, and tears. Just as in the box shape 100, the reversible envelope 102 includes a first design 52 on a first side 54 (i.e., a shipping design) and a second design 56 on a second side 58 (i.e. the inside of the envelope 102 when shipping includes a gift design). The reversible envelope 102 gives a user the option to receive a product they ordered from a retailer and then reverse (turn inside-out) the reversible envelope 102 into a beautiful gift bag to put the product they purchased in and give it to someone as a gift.

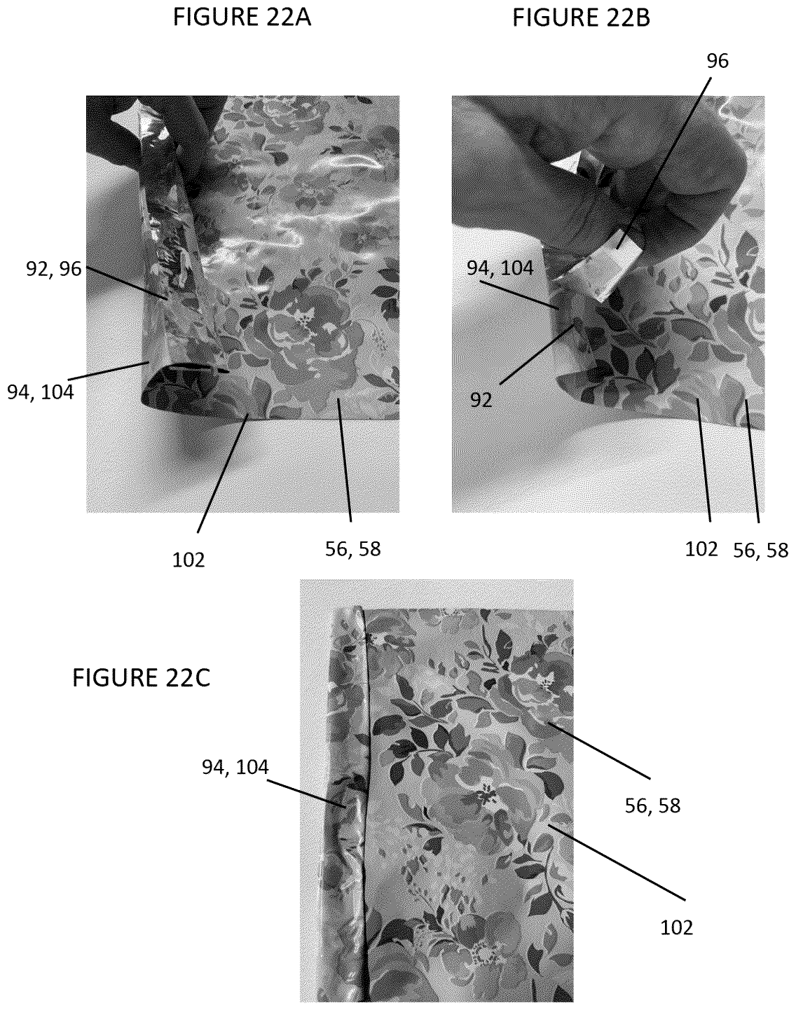

The envelope shape 102 can include a first adhesive strip 88 (for use by the shipper for mailing a product) and second adhesive strip 92 (for use by the user/gift giver) on a lip 94 to keep contents secure and tamper-proof. Any adhesive used can be a hot melt adhesive to provide security and tamper-resistance. Adhesive protectors 96 can removably cover and protect the first adhesive strip 88 and the second adhesive strip 92 (i.e., a first adhesive protector 96 can cover the first adhesive strip 88 and a second adhesive cover 96 can cover the second adhesive strip 92). The first adhesive strip 88 is located on a top portion 98 of the lip 94. The second adhesive strip is located on a bottom portion 104 of the lip 94. The top portion 98 is removably attached to the bottom portion 104 by a perforation 106 running across the lip 94. FIGS. 22A-22B show how to fold over the bottom portion 104 of the lip 94 after removing the adhesive protector 96 in order to secure the lip 94 to the packaging body 51 and secure the contents of the envelope 102.

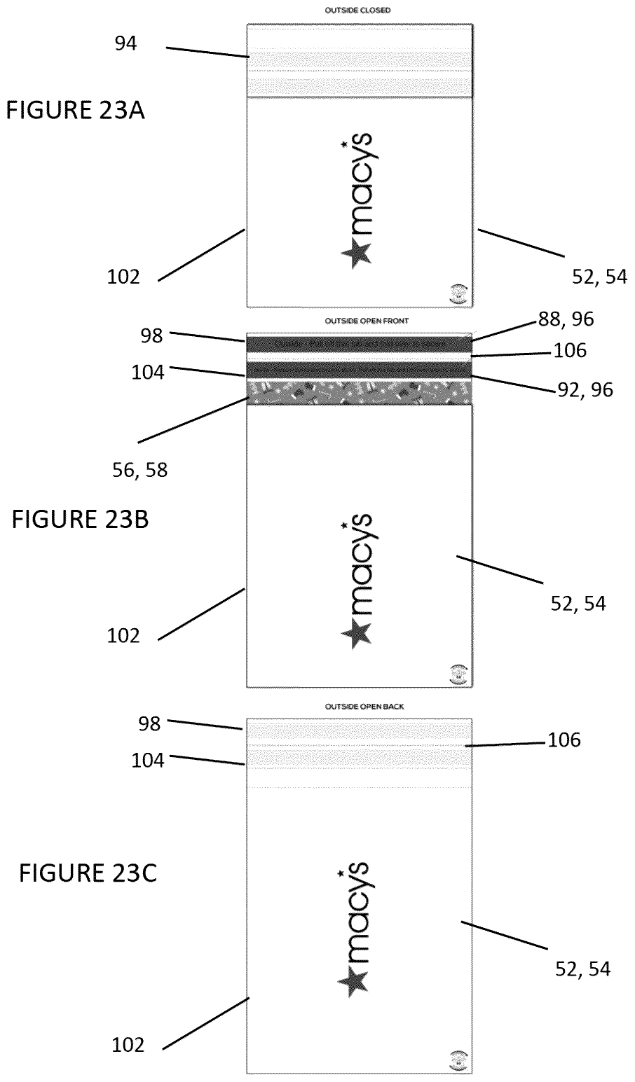

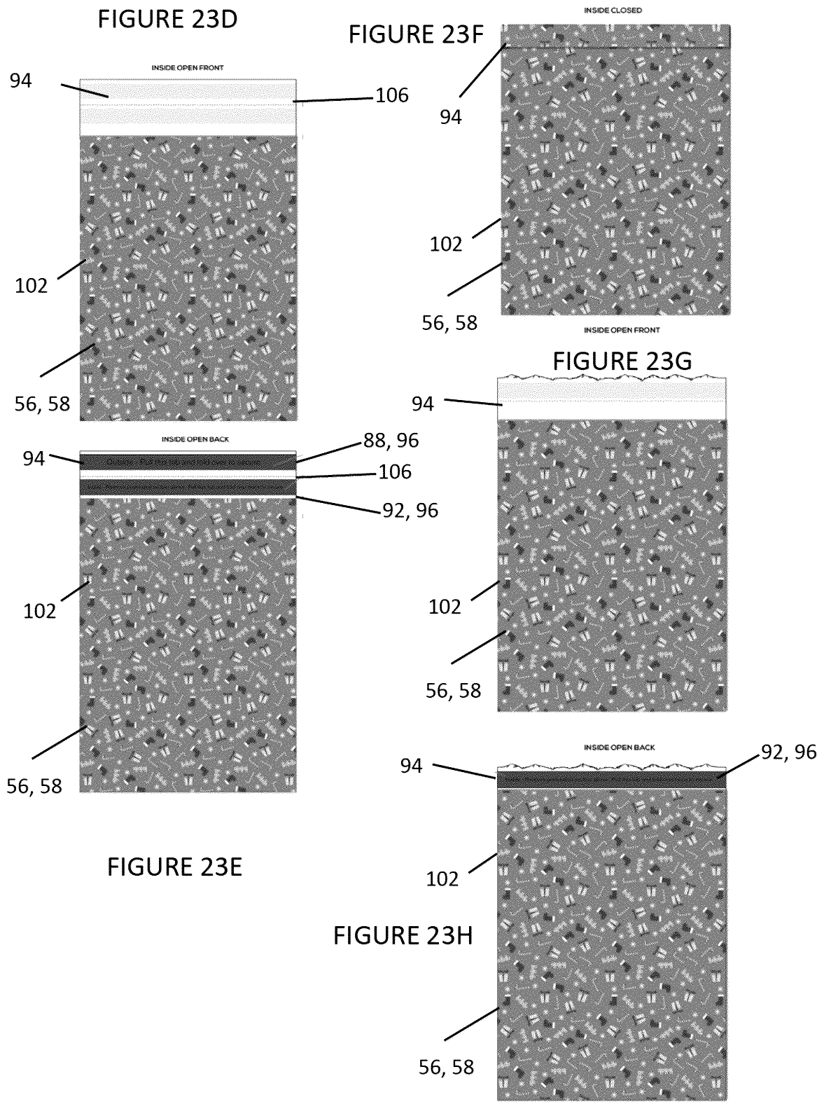

FIGS. 23A-23C show the envelope 102 in an outside closed view (FIG. 23A), an outside open front view (FIG. 23B), and an outside open back view (FIG. 23C). These views show a first design 52 of a shipping design for Macy's on a first side 54. FIGS. 23D-23H show the envelope 102 once it has been turned inside-out to show the second design 56 on the second side 58. FIG. 23D is an inside open front view, FIG. 23E is an inside open back view, FIG. 23F is an inside closed view, FIG. 23G is an inside open front view, and FIG. 23H is an inside open back view. FIGS. 23G and 23H show that the top portion 98 has been torn away at the perforation 106 to prepare for sealing.

In using the envelope 102, a company can send a product in the envelope 102 wherein the envelope is sealed with the first adhesive strip 88. When the user receives the envelope 102, they can open the envelope 102, turn the envelope 102 inside-out to reveal the second design 56, and tear off the top portion 98 of the lip 94. Alternatively, the top portion 98 of the lip 94 can be torn when the user initially opens the envelope 102. The user can insert the product or any other items 20 that they desire in the envelope 102. They next remove the adhesive protector 96 from the second adhesive strip 92, fold over the bottom portion 104 of the lip 94 and press the bottom portion 104 onto the packaging body 51 in order to seal the envelope 102. Similarly, when the reversible packaging 50 is a shopping bag, the user can simply turn it inside-out from showing the first design 52 to reveal the second design 56.

When the second design 56 includes a return label, the user can take a picture of the return label//read a barcode/toggle a QR code on the label with their smart device, which reads the label, and indicate that a package is being returned. Retailers/companies can also take a picture of the return label/read a barcode/toggle a QR code on the label to instantly approve a return or exchange, activating another return label and postage. The return label can induce communication with a retailer confirming a return, or communicate through a shipping application (USPS, UPS, FedEx, etc.) on a smart device to allow a user to forward a rewrapped product to anyone the user designates. This allows a product to be bought by a user and then shipped to a third party recipient. Companies can also use the label to receive merchandise and then repackage for sending to a consumer.

Therefore, the present invention also provides for a method of using reversible packaging 50, by a user purchasing a product contained within reversible packaging 50 showing a first design 52, the user removing the reversible packaging 50 and reversing the reversible packaging 50 to show a second design 56, and the user securing the reversible packaging 50 around the product showing the second design 56. In order to reverse the reversible packaging 50, the user can disassemble the box 100 showing the first design 54 and reassemble the box 100 showing the second design 56 as describe above. When the box 100 includes a top body 66 and bottom body 68, each of these can be disassembled showing the first design 54 and reassembled to show the second design 56. When the reversible packaging 50 is an envelope 102, the user can reverse it as described above. The user can generally form the reversible packaging 50 to show the second design 56 and then place the product within the reversible packaging 50 before securing by the sealing mechanism. The method can further include the step of the user giving the product as a gift to an individual. The method can include the user taking a picture of a return label//reading a barcode/toggling a QR code and sending the product to a company for a return. The method can include the user taking a picture of a return label//reading a barcode/toggling a QR code and sending the product to another individual as a gift. The method can include the user being a company and taking a picture of a return label//reading a barcode/toggling a QR code and sending the product to a consumer.

Throughout this application, various publications, including United States patents, are referenced by author and year and patents by number. Full citations for the publications are listed herein. The disclosures of these publications and patents in their entireties are hereby incorporated by reference into this application in order to more fully describe the state of the art to which this invention pertains.

The invention has been described in an illustrative manner and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A balloon comprising an inflatable body operatively attached to a base on a proximal side, said base including a cavity for filling with items, wherein said inflatable body is inflated by an air source chosen from the group consisting of an air vent and a fan operatively attached to said base.

2. The balloon of claim 1, wherein said inflatable body is made from a material chosen from the group consisting of polyethylene, biaxially-oriented polyethylene terephthalate, and foil.

3. The balloon of claim 1, wherein said inflatable body includes at least one vent for gradually releasing air from said balloon.

4. The balloon of claim 1, wherein said inflatable body includes a design on a location chosen from the group consisting of a front side and a front and back side.

5. The balloon of claim 1, wherein said design is chosen from the group consisting of a holiday greeting, congratulations, a birthday message, a personal message, cartoon characters, general celebratory designs, sports teams logos, corporate designs, fundraiser designs, and promotional advertisements.

6. The balloon of claim 1, wherein at least a portion of said inflatable body can be colored in with a coloring device.

7. The balloon of claim 1, wherein said proximal side of said base is a removable and resealable lid.

8. The balloon of claim 1, wherein a distal side of said base is a removable and resealable lid.

9. The balloon of claim 1, wherein said cavity is sealed with a tamper proof seal.

10. The balloon of claim 1, wherein said base includes an opening on a distal side to receive air from said air source, and wherein said proximal side includes an opening so that air flows to said inflatable body.

11. The balloon of claim 10, wherein said opening on said distal side includes a raised lip extending to said proximal side.

12. The balloon of claim 1, wherein said base includes a plurality of air intake slots to receive airflow from said air source.

13. The balloon of claim 1, wherein said base is made of a material chosen from the group consisting of polyethylene terephthalate (PET), recycled polyethylene terephthalate (rPET), polyactic acid (PLA), polyvinyl chloride (PVC), amorphous polyethylene terephthalate (APET), and electro static dissipation plastic.

14. The balloon of claim 1, wherein said base is see-through such that items within said base can be viewed.

15. The balloon of claim 1, wherein said items are chosen from the group consisting of candy, chocolates, cookies, nuts, snacks, t-shirts, socks, wallets, belts, jewelry, perfume, gifts, golf balls, golf tees, games, construction blocks, sports cards, art supplies, markers or stickers for do-it-yourself kits, and promotional items.

16. The balloon of claim 1, wherein said items are in a resealable pouch.

17. The balloon of claim 1, wherein said inflatable body is secured with a securing mechanism to said base until ready for use.

18. The balloon of claim 1, wherein said air source is a fan, and said balloon further includes a power cord for connecting to a power source to power said fan.

19. The balloon of claim 1, wherein said air source is a fan, and said base further includes an internal battery for powering said fan operated by an on/off switch.

20. The balloon of claim 1, further including LED light strips operatively attached to said base.

21. The balloon of claim 1, further including packaging containing said balloon, wherein said packaging is reversible and includes a first design on a first side and a second design on a second side.

22. The balloon of claim 21, wherein said first design is shown in a store and said second design is a gift wrap design.

23. The balloon of claim 21, wherein said packaging includes a cut out on a distal side through which said base fits such that said base protrudes through said cut out, while said inflatable body remains within said packaging under a proximal side.

24. The balloon of claim 21, wherein said packaging includes adhesive for securing said second design around said balloon.

25. A method of using a balloon, including the steps of:
placing the balloon at a display location, wherein the balloon includes an inflatable body operatively attached to a base on a proximal side, the base including a cavity for filling with items;
flowing air through the inflatable body;
inflating the inflatable body; and
providing access to the items within the cavity.

26. The method of claim 25, wherein said flowing air step is further defined as flowing air by a mechanism chosen from the group consisting of an air vent and a fan operatively attached to the base.

27. The method of claim 25, wherein the mechanism is an air vent, and said flowing air step further includes the step of plugging the fan in with a power cord.

28. The method of claim 25, wherein said placing step further includes the step of removing a securing mechanism attaching the inflatable body to the base.

29. The method of claim 25, wherein said inflating step further includes the step of displaying a design on the inflatable body.

30. The method of claim 25, wherein the items are chosen from the group consisting of candy, chocolates, cookies, nuts, snacks, t-shirts, socks, wallets, belts, jewelry, perfume, gifts, golf balls, golf tees, games, construction blocks, sports cards, art supplies, markers or stickers for do-it-yourself kits, and promotional items.

31. The method of claim 25, wherein said providing access step is further defined as opening a removable lid on the base.

32. The method of claim 31, further including the step of opening a tamper proof seal sealing the cavity.

33. The method of claim 25, further including the step of resealing a resealable pouch containing the items.

34. The method of claim 25, further including the step of refilling the cavity with items.

35. The method of claim 25, further including before said placing step, the step of a user securing packaging around the balloon showing off a first design or a second design.

36. The method of claim 25, further including before said placing step, the step of a user applying color to the inflatable body with a coloring device.

37. The method of claim 25, further including the step of illuminating LED lights on the base with a power cord.

38. A reversible packaging comprising a packaging body including a first design on a first side and a second design on a second side, said packaging body being reversible and said packaging body including at least one sealing mechanism for sealing said reversible packaging around a product.

39. The reversible packaging of claim 38, wherein said first design shows a design chosen from the group consisting of contents of said packaging body, information that is commercially required or regulatory required, a display for a sales shelf, packaging for shipping, safety information and combinations thereof.

40. The reversible packaging of claim 38, wherein said second design is chosen from the group consisting of a gift wrap design, a return label, and combinations thereof.

41. The reversible packaging of claim 38, wherein said second design is a gift wrap design and is chosen from the group consisting of a holiday design, a congratulatory design, a birthday design, a personal message design, cartoon or other licensed character design, a general celebratory design, a sports teams logo, a corporate design, a fundraiser design, and a promotional advertisement.

42. The reversible packaging of claim 38, wherein said first side includes a first sealing mechanism for securing said packaging body around a product showing said first design, and wherein said second side includes a second sealing mechanism for securing said packaging body around the product showing said second design.

43. The reversible packaging of claim 38, wherein said first sealing mechanism is chosen from the group consisting of adhesive, glue, hook and loop, and tabs, and wherein said second sealing mechanism is chosen from the group consisting of adhesive, glue, hook and loop, and tabs.

44. The reversible packaging of claim 38, wherein said packaging body forms a shape with said second side chosen from the group consisting of the same shape as said first side and a different shape from said first side.

45. The reversible packaging of claim 38, wherein said packaging body further includes perforations allowing said packaging body to be broken down into a smaller size when showing said second design.

46. The reversible packaging of claim 38, wherein said reversible packaging is in the shape of a box.

47. The reversible packaging of claim 46, wherein said packaging body includes a top body and a bottom body wherein said top body fits over said bottom body forming a box.

48. The reversible packaging of claim 47, wherein said top body includes said first design on said first side and said second design on said second side, and wherein said bottom body includes said first design on said first side and said second design on said second side.

49. The reversible packaging of claim 46, wherein said packaging body includes a lid having tabs on a front flap configured to be received by slots formed by side panels.

50. The reversible packaging of claim 46, wherein said packaging body includes a lid having a receiving slot for receiving a tab from a front panel.

51. The reversible packaging of claim 38, wherein said reversible packaging is in the shape of an envelope.

52. The reversible packaging of claim 51, wherein said envelope is a flat lay poly mailer.

53. The reversible packaging of claim 51, wherein said second design is revealed by turning said envelope inside-out.

54. The reversible packaging of claim 51, wherein said envelope includes a first adhesive strip on a top portion of a lip and a second adhesive strip on a bottom portion of a lip.

55. The reversible packaging of claim 54, further including a first adhesive protector removably covering said first adhesive strip and a second adhesive protector removably covering said second adhesive strip.

56. The reversible packaging of claim 54, wherein said top portion of said lip is removably attached to said bottom portion by a perforation running across said lip.

57. The reversible packaging of claim 38, wherein said reversible packaging is in the shape of a shopping bag.

58. A method of using reversible packaging, including the steps of:
a user purchasing a product contained within reversible packaging showing a first design;
the user removing the reversible packaging from around the product and reversing the reversible packaging to show a second design; and
the user securing the reversible packaging around the product showing the second design.

59. The method of claim 58, wherein said securing step is further defined as the user using a sealing mechanism for securing the reversible packaging around the product chosen from the group consisting of adhesive, glue, hook and loop, and tabs.

60. The method of claim 58, wherein the first design is chosen from the group consisting of contents of said packaging body, information that is commercially required or regulatory required, a display for a sales shelf, packaging for shipping, safety information and combinations thereof.

61. The method of claim 58, wherein the second design is chosen from the group consisting of a gift wrap design, a return label, and combinations thereof.

62. The method of claim 58, wherein said second design is a gift wrap design and is chosen from the group consisting of a holiday design, a congratulatory design, a birthday design, a personal message design, cartoon or other licensed character design, a general celebratory design, a sports teams logo, a corporate design, a fundraiser design, and a promotional advertisement.

63. The method of claim 58, wherein the reversible packaging is in the shape of a box.

64. The method of claim 63, wherein said revering step further includes the user disassembling the box showing the first design and the user reassembling the box showing the second design.

65. The method of claim 63, wherein the packaging body includes a top body and a bottom body wherein the top body fits over the bottom body forming a box.

66. The method of claim 65, wherein the top body includes the first design on the first side and the second design on the second side, and wherein the bottom body includes the first design on the first side and the second design on the second side.

67. The method of claim 66, wherein said reversing step further includes the user disassembling the top body and the bottom body showing the first design, and the user reassembling the top body and bottom body to show the second design.

68. The method of claim 58, wherein the reversible packaging is in the shape of an envelope.

69. The method of claim 68, wherein said reversing step is further defined as turning the envelope inside-out to show the second design.

70. The method of claim 69, wherein said securing step is further defined as tearing off a top potion of a lip, removing an adhesive protector covering an adhesive strip on the lip, folding over a bottom portion of the lip, and pressing the bottom portion onto the packaging body.

71. The method of claim 58, further including the step of the user giving the product as a gift to an individual.

72. The method of claim 58, wherein the second design includes a return label and further including the step of the user performing a step chosen from the group consisting of taking a picture of a return label, reading a barcode, and toggling a QR code.

73. The method of claim 72, further including a step chosen from the group consisting of the user sending the product to a company for a return, the user sending the product to another individual as a gift, and the user being a company and sending the product to a consumer.

74. The method of claim 73, wherein the user sends the product to a company for a return, and further including the step of the company performing a step chosen from the group consisting of taking a picture of the return label, reading the barcode, and toggling the QR code and approving a return or exchange.

75. The method of claim 58, wherein the reversible packaging is in the shape of a shopping bag.
